(19) United States
(12) Patent Application Publication
(10) Pub. No.: US 2018/0165279 A1
(43) Pub. Date: Jun. 14, 2018

(54) MACHINE TRANSLATION SYSTEM AND METHOD

(71) Applicant: Adventor Management Limited, Dubai (AE)

(72) Inventor: Alibek ISSAEV, Dubai (AE)

(21) Appl. No.: 15/893,343

(22) Filed: Feb. 9, 2018

Related U.S. Application Data
(63) Continuation-in-part of application No. 15/159,330, filed on May 19, 2016, now abandoned.
Application No. 15/159,330 is a continuation of application No. 14/673,268, filed on Mar. 30, 2015, now abandoned.
(60) Provisional application No. 61/971,764, filed on Mar. 28, 2014.

(51) Int. Cl. G06F 17/28; G06F 17/27

(52) U.S. Cl. CPC G06F 17/289; G06F 17/2872; G06F 17/277; G06F 17/2755; G06F 17/2735

(57) ABSTRACT

A machine or computer rule-based based translation system and method which translates texts (conveying their meanings) from one natural language to another. The system and method have a modular structure for organizing languages, which in combination with a transitory (indirect) method of translation allows for the creation of a multilingual system that is capable of translations in any direction between any of the included languages. Every linguistic module includes a dictionary of words and phrases, a list of operational functions, and parameters that guide the conversion processes needed to perform a translation from one language to another.

### CROSS REFERENCE

The present application is a continuation-in-part of U.S. application Ser. No. 15/159,330, filed on May 19, 2016, which was a continuation application of non-provisional U.S. application Ser. No. 14/673,268, filed on Mar. 30, 2015, which claims the priority benefit of U.S. Provisional Application Ser. No. 61/971,764, filed on Mar. 28, 2014, the contents of application Ser. Nos. 15/159,330, 14/673,268, and 61/971,764, are hereby incorporated by reference in their entirety.

### FIELD OF THE INVENTION

The present invention relates generally to the field of machine or computer based translation systems and methods, and more particularly to a machine or computer translation system and method that performs translation of written text from one natural language into another using self-learning techniques and a modular organization of languages, together with a transit process of translation. This provides creation of a multilingual system with the ability to translate in all directions between all integrated languages. As used herein, “translation” is intended to mean a conversion of the meaning of an expression or word in one language to the same meaning in another language.

### BACKGROUND

Various types and configurations of computer based translation systems and methods have been known in the art. These prior art systems and methods have lacked versatility and speed. Some prior systems and/or methods have relied on a character recognition process which slows down the analysis.

### SUMMARY OF THE INVENTION

As noted above, the present inventions are directed to a system (sometimes hereinafter referred to as the “MTS”) and method based on self-learning techniques and that have a modular organization of languages, together with a transit method of translation. Each language module includes dictionaries, service lists and rules, which control necessary conversions of text during translation from one language into another. The transit method of translation is an option of using a transit language or multiple languages during translation between languages. For transit languages there is no morphological synthesis, and a fully analyzed (tagged) sentence is used for further translation.

There are three basic stages in the process of translation by means of the MTS, the “present invention”. These include: (i) an analysis of source text; (ii) the translation itself; and (iii) the synthesis of the translated text.

The translation part of the present invention is composed of two principal parts, (i) a translation core (includes a variety of modules, each of which produces a certain stage of text processing) and (ii) an additional module (used in operation process). The additional module may be maintained remote from said core on a server separate and apart from the core (sometime herein referred to as a “translation server”), but which may be coupled to the core.

All actions in the system are carried out by the rules, written on an internal programming language of the translation system. Separate lists of rules are called Grammars.

Structural elements of the Translation Core include the following modules:
(i) a Language Detection Module (for inputting the source text into the system;
(ii) A Rules Processing Module (the main module is responsible for the correct operation of the rules, without which the other modules cannot work);
(iii) Lexical Analyzer (responsible for a lexical analysis of the source text);
(iv) Text Analysis Module (produces an analysis of the source text);
(v) Translation Module (produces the text translation from the source language to the result one);
(vi) Memory Translation Module (the module that provides the Memory Translation); and
(vii) Text Synthesis Module (performs synthesis in the resulting language).

Contents of the additional modules vary depending on the languages used for translation and include at least two modules: a Rules and Grammar module, and a Dictionary Block.

The structural elements of the Rules and Grammar module include:
(i) Attributes (determine parts of speech and their possible properties and characteristics);
(ii) Dependencies (grammatical relations between two words within a sentence); and
(iii) Grammars (serve to transform linguistic information and consist of lists of rules).

The structural elements of the Dictionary Block include (dictionaries of the invention are structured as data bases):
(i) Orthographic Dictionary (contains words with all distinctive attributes);
(ii) Translation Dictionary (contains word-by-word translation from one language into another); and
(iii) Memory Translation Dictionary (built on the principle of memory translation).

The orthographical dictionary is a dictionary that contains words with all distinctive attributes for each language. A word's entry in the orthography contains its morphology and various attributes that have been assigned to it. The dictionary is structured in groups with an indication of all possible variations of a word usage, but without translation.

The translation dictionary consists of consecutive entries, which contain word-by-word translation from one language into another. The translation dictionary also includes translations of phrases. The mechanics of phrases used within the translation system allows to transform the meaning of a phrase and grammatical dependencies between words from one language into another.

The memory translation dictionary operates with ready-made phrases, obtained as a result of the statistical approach of choice of the translation options. There is a statistical calculation based on the entered phrases, in result one that occurs most often is chosen. This uses a simplified approach to phrase organizing, as compared to translation dictionary. In other words, the system keeps successful translation examples defined by linguists in a special database.

Analysis of the source text results in an unambiguous identification of all parts of speech and dependencies between words. (dependencies as a rule, are a set of grammatical relations between two words within a sentence).

At the translation itself stage, word meanings are translated into another language, words change their position in accordance with the target grammar, and dependencies get transformed as well.

During the synthesis stage, final modification is made. These include replacement and insertion of service words, and adjustment of endings.

Each of the listed stages utilizes rules of text transformation, which are consolidated into grammars.

Synthesis results in a fully tagged structure of a sentence. This is why such a sentence can be easily translated into any other language without having to run analysis. Transit translation is based on this principle.

Accordingly, the translation server has a linguistic module of a dictionary of words and phrases, a linguistic module of a list of operational functions, and parameters that guide a conversion processes needed to perform a translation from one language to another. The translation server is further configured for effecting analysis of said source text for identification of all parts of said text and dependencies between words of said text, and for effecting translation of said source text into a target language text and for displaying said target language text. The system is based on grammar and rules, wherein said grammar is a functional block that transforms linguistic information and includes a of list of rules, which are performed consecutively, and a translation dictionary which includes translation of words and phrases from one language to another, said translation dictionary including consecutive entries, which contain word-by-word translation from one language into another, and further including translations of phrases from one language to another, and said translation dictionary operates with special parameterized phrases, which enables formation of translation patterns for similar source texts, wherein each parameter corresponds to a dedicated grammar which checks the correctness of word or word combination placement into a given phrase.

The method of the invention therefore includes the steps of separating a source text into tokens, identifying lexemes from the tokenization step; assigning attributes to said lexemes, analyzing said lexemes, eliminating ambiguities of said lexemes, establishing dependencies between words, applying translation grammar and synthesis grammar to the translated text in order to determine if in the translated text there are attributes assigned to each token; and dependencies between tokens, applying rules of synthesis to correct any excess or deficiency of the attributes in said translated text and any excess or absence of dependencies in said translated text, and correcting any word order in the translated text, said tokens being elements that represent a sequence of symbols grouped by predefined characteristics, including an identifier, a number, a punctuation mark, date, or word, and applying grammar and rules, said grammar being a functional block that transforms linguistic information and includes a list of rules, which are performed consecutively, wherein grammars work with incoming linguistic information, divided into tokens with defined initial attributes that are obtained from an orthographical dictionary, and wherein grammar has input parameters, through which information is received, said grammars including grammar of analysis, a grammar of translation; and a grammar of synthesis, and operational grammars including a grammar of service, a grammar of dictionary; and a grammar of assistant, and a dedicated orthographical dictionary which contain words with all distinctive attributes,

The foregoing provides a user preference-based language detection system that allows for the more accurate detection of the language of correspondence, particularly for example, languages as closely related as Russian and Ukrainian. The improved language detection system will be particularly useful when using the translation system with messaging apps or chats, i.e. when translating in real-time communication.

The present invention takes into account a users' gender, allowing for more precise translation into languages with gendered words. This is useful when translating real-time communication in messages and chats using the translation system.

The system of the invention allows a methodology for the detection of formal/informal communication modes. This will make translation more flexible so that the translation system can adjust to a users' communication style when translating real-time conversations. For instance, if communication is informal, the system will avoid using excessively polite phrases when translating.

The invention further provides an automatic dictionary compilation system that is based on statistics. This is intended to enable the translation system to automatically self-learn by translating large quantities of text corpora. This approach will bring about significant reductions to human workload.

The invention is thus directed to computer based translation system for translating text of a source language (source text) to text of a target language (target text) thereby conveying meaning of said source text from one natural language to another. The computer has a core with a modular structure supporting a plurality of modules for performing text translation. An input device is coupled with the core transmitting said text of said source language for translation to said core. Further, a screen for displaying a graphical user interface (GUI) is coupled with said core. The modules maintained on said core are for effecting analysis of said source text, identification of all parts of said source text, identification of dependencies between words of said source text, effecting translation of said source text into said target text, and for displaying said target text on said GUI. The modular structure includes: (a) a language detection module configured for inputting the text of said source language into the system; (b) a rules processing module configured for correct operation of rules which guide the functioning of other modules; (c) a lexical analyzer configured for lexical analysis of the text said source; (d) a text analysis module configured to analyze said source text; (e) a translation module configured to produce translation of the source text to the target text; (f) a memory translation module configured to provide memory translation; and (g) a text synthesis module configured to perform synthesis of the target text. At least one additional module is coupled with the core including at least a rules and grammar module, an orthographic dictionary, a translation dictionary and a memory translation dictionary. The rules and grammar module have attributes to determine parts of speech and their possible properties and characteristics, and dependencies as grammatical relations between two words within a sentence, wherein grammars transform linguistic information and consist of lists of rules. The orthographic dictionary contains words with all distinctive attributes, said translation dictionary contains word-by-word translations from one language into another, and the memory translation dictionary has ready-made phrases. In addition, a removable plug-in module which may be operatively coupled to said core supports at least a self-learning block having a matches module configured for linking words in the source text and the target text.

The present invention is also directed to a method for translation of text of a source language (source text) into a translated text conveying its meaning from one natural language to another natural language. The steps of the method include: entering said source text into a computer configured to perform said translation through a graphical user interface, said graphical user interface being coupled to a core of said computer; analyzing said source text; translating the source text into a translated targeted text; synthesizing the translated targeted text; and analyzing source and target texts thereby establishing matches for automatically filling the dictionaries with new phrases for self-learning. The step of analyzing said source text divides strings of symbols into separate words and results in an unambiguous identification of all parts of speech, wherein said step of analyzing said source text further results in a set of grammatical relations between two words within said source text known as dependencies. The step of translating involves word meanings being translated into a target language through the use of dictionaries, and changing the position of words in accordance with the grammar of the target language, and wherein said dependencies become transformed. The step of synthesizing includes replacement and insertion of service words, and adjustment of endings, applying rules of text transformation, which are consolidated into grammars for each of said steps of analyzing said source text; translating the source text into a translated text; and synthesizing. The step of synthesizing results in a fully tagged structure of text in the target language without analysis, wherein said synthesizing into a fully tagged structure of text in the target language without analysis is a transit translation. Finally, conveying said translated text to an output on a graphical user interface for viewing said target text.

An important feature of this approach is that it combines the statistical selection of translation variants and the self-learning of the system. This approach is intended to overcome situations in which translation quality grows increasingly slowly despite growing text corpora (i.e. saturation of the dictionary occurs). At the same time, there is a capability whereby a linguist can adjust the depth of self-learning. It is now also possible to obtain more phrases by increasing the degree of parameterization. It is noteworthy that incorrect phrases will become increasingly likely to be replaced by correct ones as the volume of text corpora increases. Furthermore, the work of rank-and-file linguists is now much easier, as all they have to do is find the right translation variants for sentences.

The foregoing summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having described embodiments of the invention in general terms, reference will now be made to the accompanying drawings, in which:

FIG. 1(a) is a representative schematic diagram broadly illustrating the method of the invention;

FIG. 1(b) is a representative schematic diagram broadly illustrating the system of the invention;

FIG. 1(c) is a representative schematic diagram illustrating in detail the system of the invention;

FIG. 2(a) is a flow chart broadly illustrating the translation process of the present invention;

FIG. 2(b) is a flow chart illustrating in more detail the translation process of the present invention;

FIG. 3 is a schematic representation illustrating the principle of filling an orthographic dictionary;

FIG. 4 is a diagram that illustrates dependencies in an English sentence;

FIG. 5 Is a diagram illustrating the operating principle of a work list;

FIG. 6(a) is a chart illustrating the principle of constructing rules;

FIG. 6(b) is flow chart showing the implementation rules;

FIG. 7(a) Illustrates creating a tree-structure of rules;

FIG. 7(b) is a flow chart illustrating the process of executing operators illustrated in FIG. 7(a);

FIG. 8 illustrates operating main grammars with an input sentence;

FIG. 9. Illustrates operating the principle of assistant grammar;

FIG. 10(a) shows the structure of phrases in a translation dictionary;

FIG. 10(b) shows the parts of a phrase structure;

FIG. 11 is a flow chart showing the system's work with phrases;

FIG. 12 is a flow chart that shows the «Match phrase» process;

FIG. 13 is a schematic that illustrates indirect (transit) translation from one language into another;

FIG. 14 is also a schematic that illustrates indirect (transit) translation from one language into another via different route than illustrated in FIG. 13;

FIG. 15 is a schematic diagram illustrating the translation method considering a form of communication;

FIG. 16 shows the operating principles of rules with a form of communication or a gender of interlocutors;

FIG. 17 illustrates an example of using the invention on a variety of devices;

FIG. 18 is a schematic diagram illustrating the invention's feature of automatically detecting identifying a language;

FIG. 19 is a block diagram illustrating the loading stage of the self-learning block of the invention;

FIG. 20 is a flow chart illustrating the process of the self-learning block; and

FIG. 21 is a flow chart illustrating the match assignment principle of tying words from an input part of a phrase to the words from an output part.

### DESCRIPTION OF EXEMPLARY EMBODIMENTS

The basic elements of the system include:
(i) Lexical units (corresponds to the set of word forms for a given word);
(ii) Attributes (determine parts of speech and their possible properties and characteristics);
(iii) Formats (represent a sequence of attributes, which can be used to describe positions of endings and more);
(iv) Dependencies (determine relations between two words in a sentence) and
(v) Grammars (serve to transform linguistic information and consist of lists of rules).

The basic elements of the system are controlled by rules (written on an internal programming language of the MTS). Rules are used for correct translation of each token (described below), sentence, or a paragraph from source language into a target language.

A token is an element that represents a sequence of symbols, grouped by predefined characteristics (for example, an identifier, a number, a punctuation mark, date, word, etc.). Tokens within a sentence are separated by a space. This way all of the elements that are located between spaces are identified by the system as separate tokens.

This MTS operates a process that is based on grammar and rules. Grammar is a functional block that transforms linguistic information and consists of a list of rules, which are performed consecutively, from top to bottom. Grammar rules, in turn, consist of a sequence of operators.

Grammars work with incoming linguistic information, i.e. with a preprocessed sentence, split into tokens with defined initial attributes that are obtained from the orthographical dictionary. Grammar has input parameters, through which information is received. Real values of parameters are sent to grammar input. These values are stored in a current list, which is an internal buffer for storing results of intermediate modifications.

Operators can produce changes in current lists. These include change, add or remove words (tokens), remove word variations, add or remove attributes and dependencies. These changes of current lists are made on sentence images and are transferred to the sentence itself only if the main grammar is triggered. If the grammar did not trigger, the image of sentence with changes is deleted and the initial sentence remains in the form it was after last being processed by grammar.

After the main grammar is triggered, all changes in the sentence become irreversible.

Grammars are split into two groups: Main grammars (also called base grammars) and Operational grammars (also called working grammars). Main grammars consist of: the grammar of (i) analysis, (ii) translation; and (iii) synthesis. Operational grammars consist of: grammars of: (i) Service; (ii) Dictionary; and (ii) Assistant.

Execution of main group grammars is initiated by the system. Operational grammars are used by the system and can also be called from the rules of main grammars and translation dictionaries.

For each language there is a dedicated orthographical dictionary. This is a dictionary that contains words with all distinctive attributes. The dictionary is structured in families with indication of all possible variations of use of a word (but without translation).

Translation of words and phrases is contained in a translation dictionary. This dictionary consists of consecutive entries, which contain word-by-word translation (one lexical unit after another), from one language into another. The translation dictionary also includes translations of phrases. The mechanics of phrases used within the MTS allows transforming the meaning of a phrase and grammatical dependencies between words from one language into another.

Translation dictionary operates with special parameterized phrases, which enables formation of translation patterns for a wide array of similar sentences. Each parameter corresponds to a dedicated grammar, which checks the correctness of word or word combination placement into a given phrase.

Placement parameters in phrases can be filtered by means of additional conditions, which are set by attributes. Attributes can also be added to a phrase, if the goal is to have correct processing of all word forms of a given word. If the goal is to have the phrase work in a wider context, then parameters will check for specific value use. This way the number of phrases that would fit a given pattern would increase.

Some phrases are set with detailing grammars (form the list of operational grammars or dictionary grammars), which allows to avoid various errors, for example those related to the written form of a word in different registers or the use of articles.

There is also another group of phrases, contextual phrases. Here, the possible context of a sentence is considered and the translation of a word depends on the surrounding context.

Any word that is absent in the orthographical dictionary can be obtained during the process of word formation. This method of processing is applied for complex words and words with prefixes and postfixes. Besides, during processing, words in the dictionary can be split into parts if needed.

Collaborative process of creating, editing and managing a machine translation system is ensured and organized by a special information system, a Linguistic Support System, (or “LSS”). LSS is a server solution with a dialog web-interface that can be accessed via a browser. It allows linguists and translators to monitor the translation process, edit dictionaries, add translations of language pairs and ensure learnability of the system. LSS features a user-friendly interface, where all linguistic instruments are organized in groups.

This way the described MTS has all of the tools required for a high quality and correct translation of text from one language into another.

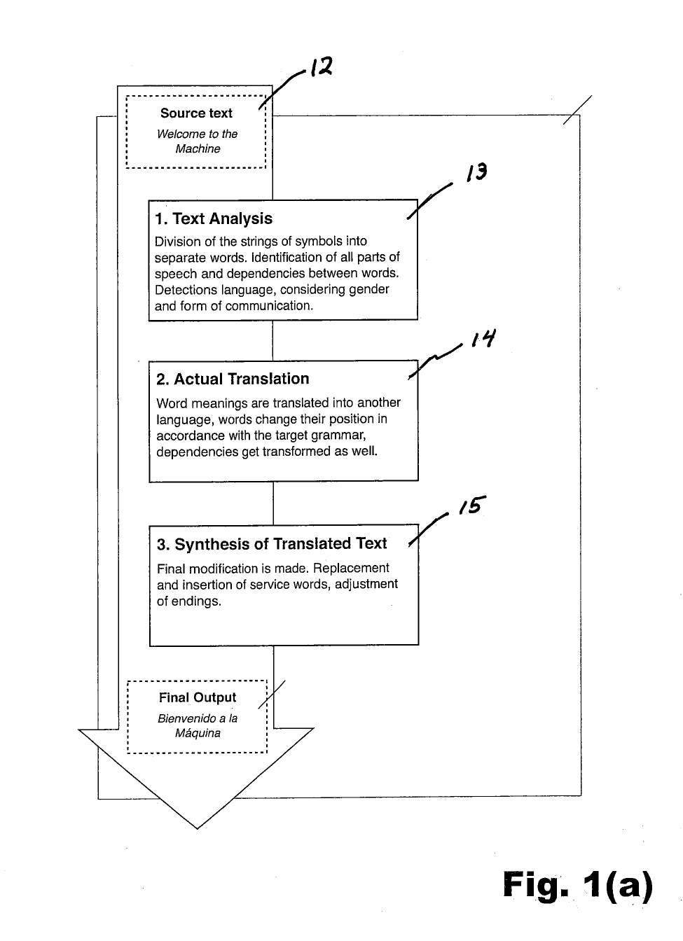

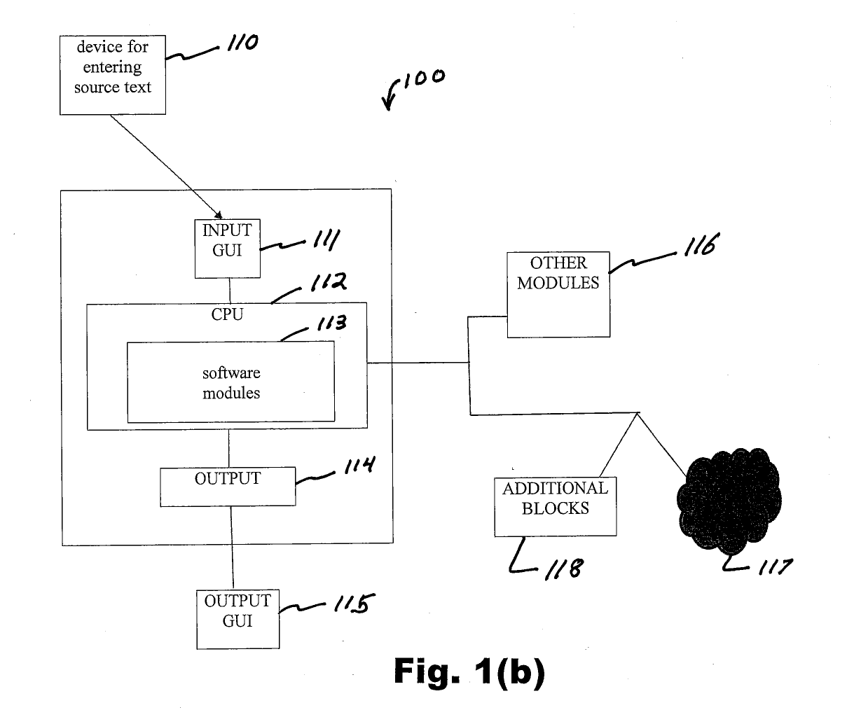

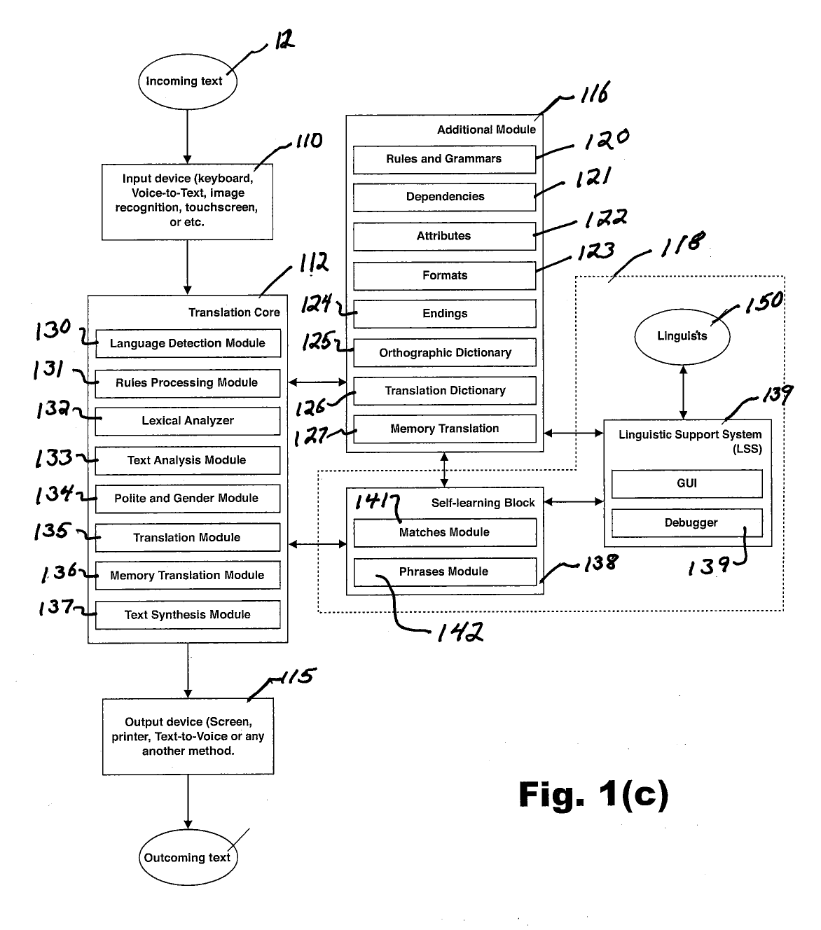

Referring now in more detail to the accompanying drawings and with particular reference to FIG. 1(a) and FIG. 1(b), the basic elements of the method of the invention and of the machine translation system of the invention (“MTS”), are illustrated. The method of the invention includes entering source text 12 into the system which translates the text 12 (conveys their meanings) from one natural language to another language at the final output 16.

The MTS has a modular organization, which together with the transit method of translation, provides creation of a multilingual system with the ability to translate in all directions between all integrated languages. Each language module includes dictionaries and rules, which control necessary conversions of text during translation from one language into another.

There are three basic stages in the process of translation by means of the MTS, as illustrated in FIG. 1(a). These consist of an analysis 13 of source text, the actual translation 14 of the source text, and synthesis 15 of translated text.

During the analysis part 13 there is a division of the strings of symbols into separate words (lexemes). Analysis results in unambiguous identification of all parts of speech and dependencies between words (dependencies, as a rule, are a set of grammatical relations between two words within a sentence).

At the translation stage 14 word meanings are translated into another language. Words change their position in accordance with the target grammar, and dependencies get transformed as well.

During the synthesis stage 15, final modification is made (including replacement and insertion of service words and adjustment of endings). Synthesis results in a fully tagged structure of a sentence at the output 16. That is why such a sentence can be easily translated into any other language without having to run analysis. Transit translation is based on this principle.

The system 100 of the invention, as shown in FIG. 1(b), includes: an input graphical user interface (“input GUI”) 111 which can be displayed on a typical computer screen; a central processing unit (“CPU”) or core 112 which is coupled to the input GUI, and an output point 114. The CPU 112 contains software modules 113 for generating and/or recognizing tokens, lexemes, attributes, formats, dependencies, functional grammars, dictionaries and other elements of the system, all for performing the process of the invention. Source text 11 to be translated may be entered onto the input GUI in appropriate fields using a typical inputting device, such as a keyboard 110, and the translation process can then be initiated by the well-known technique of “clicking” on an appropriate starter button displayed on the input GUI. After the process of translation, according to the present invention, is complete, the targeted language text will be outputted from the system at an outpoint point 114 so that it can be displayed on an output GUI 115. The GUI may also be coupled to other functioning modules 116, to the Internet or cloud 117 for accessing other functions, or to additional blocks for additional functionality.

The system 100 of the invention is modular and structured for organizing languages, which in combination with a transitory (indirect) method of translation (described below) allows for the creation of a multilingual system that is capable of translations in any direction between any of included languages.

Every linguistic module includes a dictionary of words and phrases, a list of operational functions, and parameters that guide the conversion processes needed to perform a translation from one language to another.

To fully appreciate how the machine translation system 100 works, it is necessary to have a good understanding of precisely how each of its structural elements function. These include the system elements of lexemes, attributes, formats, dependencies, and functional grammars. This more detailed explanation is found below in connection with FIG. 1(c). However, prior to a discussion of the structural elements of the invention, there will first be described the translation process.

### The Translation Process

As noted above, the operating principles of the system of the invention are illustrated in FIG. 1(a) and are described below in more detail in connection with an example of a sample sentence translation. The more detailed description below includes a description of various system components. The translation process may be divided into the three basic phases, described above:
(i) Analysis of input text 13
(ii) Direct word-for-word translation 14
(iii) Synthesis of the translated text 15.

A fourth basic phase includes parallel analysis of source and target texts establishing matches for self-learning.

Analysis 13 determines all parts of speech and establishes the relationships between words. During Translation 14 all words are translated to the output or target language, which are in turn arranged into the appropriate structures in accordance with the grammar and word relationships of the target language. Synthesis 15 performs the final modifications, rearranging the text and adding proper endings. Every step uses a set of rules for text conversion that are incorporated into operational grammars.

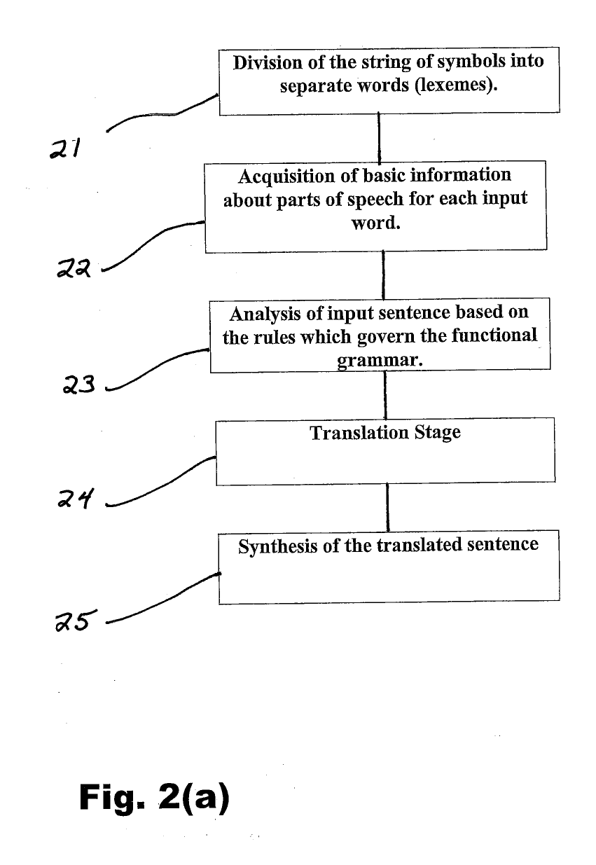

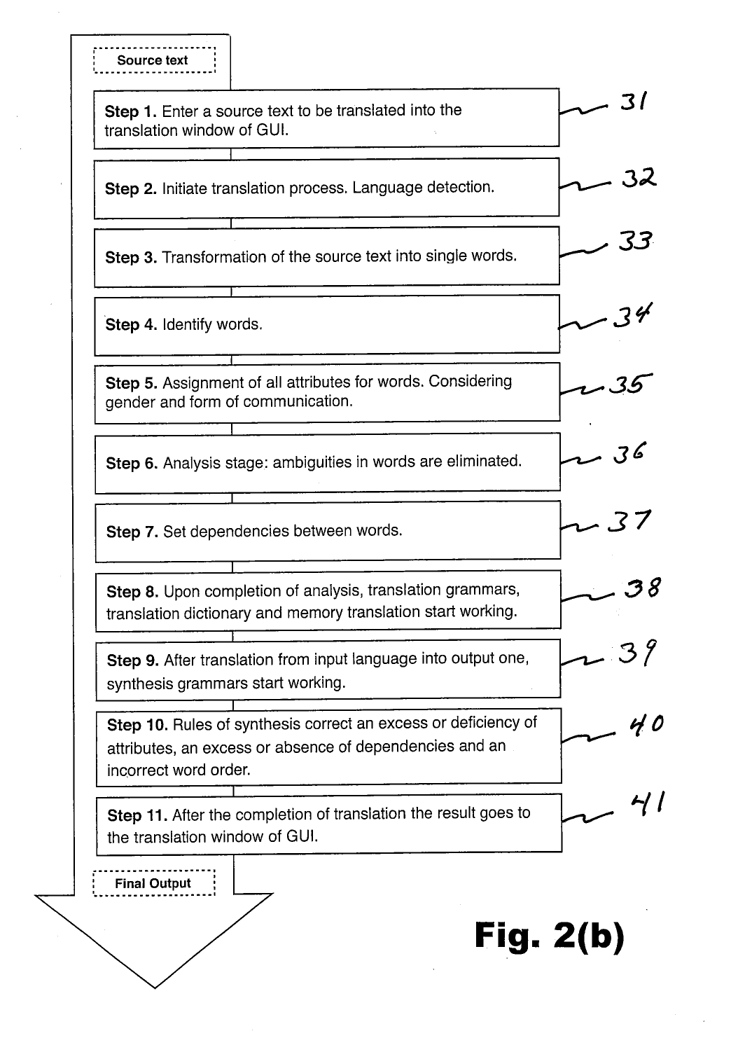

The processing of information in the system is shown in FIG. 2(a). As illustrated and described below, a simple sample sentence is translated from English to Russian in five broadly categorized steps. (A more detailed description of the translation process will be given below in connection with FIG. 2(b).

Input sentence: A girl eats an apple.

First Step 21. Division of the string of symbols into separate words (lexemes)

```
A
  girl
    eats
      an
        apple
```

Second Step 22. Acquisition of basic information about parts of speech for each input word. This information is taken from the English orthographic dictionary:

```
A UPPERFIRST
  a Sg Art
girl
  girl N Sg SCase Anim
eats
  eats(eat) V VV Pres Sg ThPson Time Vi
an
  an Sg Art
apple
    apple N Sg SCase Food Fruit
    apple Adj
```

Here the following values are used:
Art—aticle
N—noun
V—verb
Adj—adjective

Third Step 23. Analysis of input sentence based on the rules which govern the functional grammar of the English language.

| A UPPERFIRST LinkArt.L(girl) | |
|---|---|
| | a Sg Art |
| girl Sub LinkArt.R(A) SubjPred.L(eats) | |
| | girl N Sg SCase Anim |
| eats | SubjPred.R(girl) DirObj.L(apple) |
| | eats(eat) V VV Pres Sg ThPson Time Vi |
| a | LinkArt.L(apple) |
| | a Sg Art |
| apple | Sub LinkArt.R(a) DirObj.R(eats) |
| | apple N Sg SCase Food Fruit |

The word apple has only one part of speech-noun. This choice is made because of the fact that it follows an article “the”.

The relationships between words are also established. Articles are attached to their corresponding words with the dependency Lin kArt, subject to predicate-SubjPred, verb to direct object-DirObj.

Fourth Step 24. Translation stage—described in translation grammar.

Translation of words:

| | | |
|---|---|---|
| girl | >>> | [symbol] |
| eat | >>> | [symbol] |
| apple | >>> | [symbol] |

Translation of dependency:

```

[symbol]
(girl) [symbol] [symbol]    .L(ecTb)

[symbol]

[symbol]

[symbol]

[symbol]

[symbol]

[symbol]

[symbol]

ecTb (eats) [symbol]  HacT [symbol]  .R( [symbol]   ) [symbol]  .L( [symbol]   )
  ecTb [symbol] [symbol]    HCoB [symbol]
(apple) [symbol] [symbol]    .R(ecTb) [symbol] [symbol] [symbol]
  Pc [symbol]
```

As there are no articles in the Russian language, LinkArt isn't used. The dependency SubjPred is swapped with [symbol] and DirObj becomes [symbol] ( [symbol] [symbol] [symbol] [symbol] [symbol] —Direct object in accusative case).

Fifth Step 25. Synthesis of the translated sentence—described by the functional grammar of synthesis.

```

[symbol]
(girl) [symbol] [symbol]    .L(ecT)

[symbol]

[symbol]

[symbol]

[symbol]

[symbol]

[symbol]

[symbol]

ecT (eats) [symbol]  HacT HCoB [symbol]  .L( [symbol]   ) [symbol]  .R( [symbol]   )
  ecT (ecTb) IIep [symbol]  HCoB HacT [symbol] [symbol] [symbol] [symbol]
(apple) [symbol]  IIB [symbol]  .R(ecT) [symbol] [symbol] [symbol]
  Pc [symbol] [symbol] [symbol]
```

In this step change is made to the verb «eCTb»—Infinitive becomes the 3rd person form. Cases are also determined, as well as other necessary information.

After synthesis we receive the output sentence in Russian— [symbol] [symbol] [symbol] .

After synthesis 15 we have the fully outlined structure of the sentence. This enables the sentence to be easily translated to any other language without the need to repeat the analysis step 19. Transitive translation is based on this principle.

Self-learning involves analyzing both source and target texts by a methodology consisting of rules bundled into grammars for matches and filling the dictionary with new phrases created from the parallel texts. Based on the information generated in the process, the system self-learns.

FIG. 2(b) contains a more detailed flow chart of the foregoing process and outlines the basic operational principals of the system. Here eleven steps of the process are outlined and we can see the entire process of direct translation from one language into another, as follows:
(i) first, a source text to be translated is entered into the translation window of GUI (step 31);
(ii) initiate translation process, language detection (step 32);
(iii) transformation of the source text into single words (step 33);
(iv) identify words (step 34);
(v) assignment of all attributes for words, considering gender and form of communication (step 35);
(vi) analysis stage: ambiguities in words are eliminated (step 36);
(vii) set dependencies between words (step 37);
(viii) upon completion of analysis, translation grammars, translation dictionary and memory translation start working (step 38);
(ix) after translation from input language into output one, synthesis grammars start working (step 39);
(x) rules of synthesis correct an excess or deficiency of attributes, an excess or absence of dependencies and an incorrect word order (step 40);
(xi) after the completion of translation the result goes to the translation window of GUI at 41.

The final output of the translation process can then be viewed.

As can be appreciated from the foregoing description, in connection with FIG. 2(b) the basic operational principles of the system, for the whole process of direct translation from one language into another, are described. As shown in FIG. 1(a), there are three basic stages of translation: text analysis, actual translation and synthesis of translated text, plus a key step of self learning. But each of these stages comprise numerous steps. The text analysis stage is performed in steps 31-37. The actual translation is described in step 38. All subsequent steps are related to the last stage of synthesis of translated text.

The process described above is used for translation from one language into another when we have a translation dictionary with direct phrases and word translation. But it is also possible to perform indirect (transit) translation in the system.

By way of example, the following sentence will be used in conjunction with the process of FIG. 2(b) for translation into Russian: “I go to the USA on Jan 1, 2014.” As an aid to this explanation, fragments of a trace from the Linguistic Support System (“LSS”) will be used. The trace automatically appears on a screen coupled to the computer after entering the sentence at step 31 to be translated into the translation window and pressing a Translate button to initiate the process at step 32.

The next step 33 is the tokenization of the input text for transformation into single words. After separation of a sentence into tokens we have the following list for our English sentence to be translated:

01 .
02 I UPPERFIRST
03 go
04 to
05 the
06 USA UPPERALL
07 on
08 Jan UPPERFIRST
09 1st NUMBERORD
10 ,
11 2014 NUMBER YEAR
12 .

Note that both the beginning and end of the token string are marked by periods. This is an important detail, because the period at the beginning marks the beginning of the sentence and the period (or other punctuation mark) at the end of the sentence marks the end. The periods are necessary for proper operation of grammar rules.

In the trace, some tokens have general attributes:
UPPERFIRST—word begins with a capital letter;
UPPERALL—the word is written in all caps;
NUMBERORD—ordinal number;
NUMBER_YEAR—number year.

These attributes are assigned based on lexical analysis of the text. For deeper grammatical analysis additional attributes are needed, as these alone may be insufficient.

Step 34 is the identification of lexemes from the tokenization step, and step 35 is the assignment of all attributes for lexemes. Tokens from 02 to 09 in this example are lexemes and as such may be assigned ortho-attributes. A search in the orthography is conducted for each of these lexemes, and if one is not found in the orthographic dictionary (due to a spelling error or absence in the dictionary) it is assigned the attribute NOTFOUND.

In our example all of the words are written correctly, therefore we get the following trace:

```
I UPPERFIRST
    I Anim FPson Sg PnP PnWOCase SCase
  go
    go N Sg SCase Rare
    go V VV Inf Vii DInf Waway Won Wto Wby Woff Wout Wdown Waver Wthrough
Wback ...
    go(go) V VV Pres Pl Time Vii DInf Waway Won Wto Wby Woff Wout Wdown over
...
  to
    to Pr
    to PrInf
  the
    the Art
  USA UPPERALL
    USA N Pl SCase ArtThe Name CityCountry
  on
    on Adj Norm Rare
    on Pr SV
  Jan UPPERFIRST
    Jan N Sg SCase AName Anim
    Jan N Sg SCase Mon
  1st NUMBERORD
    9st Adj Norm OrdNum
  ,
2014 NUMBER _YEAR
    9 NUMBER
  .
```

Here all of the words are shown as they are found in the orthography.

For the input word “I” the orthography gives:
I Anim FPson Sq PnP PnWOCase Scase

These attributes indicate that the word is an animate pronoun, in first person, singular, and in the subjective case.

The word ‘go’ has only more than one meaning. It has three alternatives-. noun (attribute N), and 2 verb forms—infinitive (lnf) and present (Pres). Her are the attributes for the word “Jan”.

| | |
|---|---|
| Jan UPPERFIRST | // general attributes |
| Jan N Sg ECase AName Anim | // ortho-attributes(name) |
| Jan N Sg SCase Mon | // ortho-attributes(January) |

There is excess information here. A few words have multiple meanings, so at this point an unambiguous translation is impossible.

At step 36 the process of analysis grammar takes place.

In the analysis stage any ambiguities in lexemes should be eliminated, and every word should correspond to only one part of speech. It's also necessary at step 47 to establish dependencies between words.

The analysis grammar PREP ROC will be processed 12 times for each token, including the first and last periods, as follows
1) PREPROC (.)
2) PREPROC (I)
3) PREP ROC (go)
4) PREP ROC (to)
5) PREPROC (the)
6) PREPROC (USA)
7) PREP ROC (on)
8) PREPROC (Jan)
9) PREP ROC (1st)
10) PREP ROC (,)
11) PREPROC (2014)
12) PREPROC (.)

During this process not one rule was applied.

After this, the second grammar DISCONCAT is processed. Here also no rules have been applied.

Further on the grammar PREAUTO eliminated the unnecessary alternative forms of the words on, Jan.

During the process of the grammar PREAUTO, some rules were successfully applied, and the grammar was processed again for the word ‘on’. The grammar will be activated repeatedly until not one rule in the grammar can be executed. A rule is considered validated if all of the rule's conditions are met and the lexeme is modified. After this, the grammar REM RARE begins to work. It leaves only the attributes of the word go which correspond to verb forms (the attribute for noun has been eliminated).

Note that after analysis grammar has worked the example now has the following trace:

```
AFTER GRAMANALYSIS:
  .
  I UPPERFIRST . (R) SubjPred.L(go)
    I Anim FPson Sq PnP PnWOCase SCase
  go (R) SubjPred.R(I) VerbExt.L(to)
    .go(go) V VV Pres Pl Time Vii DInf Waway Wto by Woff
    Wout Wdown Wover
Wthrough Wforward Wback Walong Waround Wunder Won_Vi
  to (R) PrepSmth.L(USA) VerbExt.R(go)
    to Pr
  the (R) LinkArt.L(USA)
    the Art
  USA UPPERALL Sub (R) LinkArt.R(the) PrepSmth.R(to)
    USA N Pl SCase ArtThe CityCountry Name
  on (R) PrepSmth.L(Jan)
    on Pr SV
  Jan UPPERFIRST Sub (R) LinkName.L(1st) PrepSmth.R(on)
    Jan N Sg SCase Mon
  1st (R) LinkName.R(Jan)
    9st Adj Norm OrdNum
  ,
  2014 NUMBER_YEAR Sub
    9 NUMBER
  .
```

As result of analysis parts of speech have been established, some lexemes have been assigned additional attributes, and dependencies have been established between lexemes: subject-predicate (SubjPred), article-noun (LinkArt), preposition-noun (PrepSmth), and dependency LinkName between 1st and Jan.

Upon completion of analysis grammar work begins in translation grammar and synthesis, step 38. The operating principles for translation and synthesis grammars are similar to those of analysis grammar.

Translation grammar helps with translation of word meaning, attributes, and dependencies to the target language. The result of translation from an input language to a target language are the following elements at step 39:
Lexemes in the target language (standardized/without inflection).
A list of attributes in the target language assigned to each token.
A list of dependencies between tokens in the target language.

Usually, as result of translation, tokens in the target language have such flaws:
An excess or deficit of attributes (this interferes with declension of the word in the target language);
An excess or absence of dependencies;
Incorrect word order.

The goal of synthesis is to correct all of these problems with the help of rules, using a process analogous to the analysis process. See step 40. All rules of synthesis from the input language to the target language are grouped into the grammars of synthesis.

Note that synthesis rules in linguistic pairs cannot be used in reverse. For example, synthesis rules for English>Russian are different than the rules for Russian>English and do not fully correspond. Similarly, synthesis rules for English>Russian are different from rules for German>Russian, and so on.

### System Structure

Returning now to how the machine translation system 100 works, it is necessary to have a good understanding of precisely how each of its structural elements function. System elements include lexemes, attributes, formats, dependencies, and functional grammars.

The structural elements of the system are governed by rules. These rules are written in the internal programming language of the machine translation system. The rules are used to correctly translate each token, sentence, or paragraph from the original language to the target language.

FIG. 1(c) is an expanded and more detailed view of the structure of the system illustrated more broadly translation grammar in FIG. 1(b). Here we see that the incoming text 12 is entered into the system 100 using an input device 110, such as a keyboard, a voice-to-text converter, an image recognition system, touchscreen, or other similar means of entering text data into the system. A user does not have to indicate the incoming text's language, as it is auto-detectable.

As seen in FIG. 1(b), this text is entered through a GUI 111, which (not shown in FIG. 1(c)) is coupled to a CPU which forms the translation core 112 of the system. The Translation core 112 includes a language and detection module 130, a rules processing module 131, a lexical analyzer 132, a text analysis module 133, a polite and gender module 134, a translation module 135, a memory translation module 136 and a text synthesis module 137.

The translation core 112 is also coupled with an additional module 116 to obtain necessary word forms, phrases, rules, dependencies, and other information needed for translation. The content of the additional module's separate components depends entirely on the languages involved. Typically, they include rules and grammars 120, dependencies 121, attributes 122, formats 123, endings 124, an orthographic dictionary 125, a translation dictionary 126, and a memory dictionary 127.

When a translation has been completed, outgoing text is displayed for viewing by a user on an output device 115, such as a GUI screen, printer, text-to-voice converter, or other similar device.

In addition, the CPU 112 is operatively coupled to another two blocks: a self-learning block 138 and linguistic support system (“LSS”) 139. These blocks may be maintained separate from the translation core 112, either on a separate remote serve or in the cloud, as illustrated in FIG. 1(b) at 117. These two blocks enable a linguist 150 to operate the system's learning process, add new languages and rules, and fill dictionaries. The self-learning block empowers the system to self-learn based on the bodies of parallel texts that a linguist 150 loads into the system. The more such texts go into the system, the greater the system's self-learning rate, and the better the translation quality. The self-learning block 138 actively interacts with the translation core 112 and the additional module 116 as the system learns. The self-learning block includes a matches module 141 and a phrases module 142. This block/system will be described in greater detail below. The dashed line in the figure symbolically indicates that the self-learning block and the LSS 139 may be combined into a stand-alone component 140 to show that these are plug-in (connectable) elements as additional blocks 118. If system self-learning is not necessary, these blocks are not used. For example, when using the system in an offline mode on a separate device, these elements are not plugged in.

The whole process can run on a single device (e.g. smartphone) when a single user is performing the translation. In this case, no internet access is necessary. Other options are possible as well. For instance, a text in need of translation is sent from one device to another, on which it is translated using the translation core 112. In this case, another user will receive the translation. The Translation core 112 is also installable on remote or standalone servers to which different users can connect their respective devices.

In the following, subheadings are descriptions of elements of the MTS, as well as basic information about grammars and rules of analysis, translation, and synthesis.

### Lexemes

One of the structural elements of the system is the “lexeme.” In order to avoid the need to enter all forms of the lexeme, the MTS divides them into an unchangeable component (a “root”, or a ‘word stem’) and a changeable part (“ending”). Separate categorized endings can be used with various roots to generate lexemes (for example like=>likes, liked).

The concept of a root in the MTS does not coincide with roots in the traditional grammatical sense. In the MTS a root is the smallest unchangeable part of a lexeme. In some languages there may be no roots at all. An example of this is the irregular verb in the English language. In cases where there is no root, the special value * (asterisk) is used.

Endings not only form specific word forms, but also carry information about many characteristics of the word, such as part of speech, number, ending (masculine/feminine/neutral), case, tense, etc.

A positional method is used to classify formats which contain all of the necessary characteristics of a given word form. Here is an example. In English the majority of nouns have different endings in subjective case and possessive case, as well as in singular or plural form. By way of example, using the word ‘home’ we can illustrate the following different forms:
home—subjective case, singular;
homes—subjective case, plural;
home's—possessive case, singular;
homes'—possessive case, plural, and so on.

So, where the unchangeable portion is ‘home’, the endings will be:
-subjective case, singular;
s—subjective case, plural;
's—possessive case, singular;
s'—possessive case plural, and so on.

In summary, the process of entering a word into the orthographic dictionary is as follows:
(i) Attributes are determined which describe all possible characteristics;
(ii) Formats are given for all necessary endings;
(iii) A list of mnemonics is created for the endings;
(iv) Words are entered into the orthographic dictionary as root+description of its ending.

In this manner the process of entering words into a dictionary is greatly simplified, inasmuch as various regular word forms use the same endings.

It's also worth noting that a dictionary has a “cluster” structure and contains two types of entries:
Base lexemes; and
Sub-lexemes

Sub-lexemes are formed in a similar manner as base lexemes, they also have a single root meaning, but they are different parts of speech (or they have a significant variation in attributes), and as such require a different format. Base lexemes are listed as linear entries, and their sub-lexemes are written with an indentation. (For some words several levels of sub-lexemes are possible). Below are described several examples for the English orthographic dictionary.

### Dictionaries

Dictionaries are important components of the system. For each direction of translation there are three dictionaries: (i) orthographic dictionary of the source language; (ii) orthographic dictionary of the result (target) language; and (iii) translation dictionary from the input/source language to the result language.

The orthographic dictionary 58, or orthography, contains the word forms of various words and their attributes which describe various syntactical and semantic characteristics. The translation dictionary establishes correlations between words and phrases in both input and output languages.

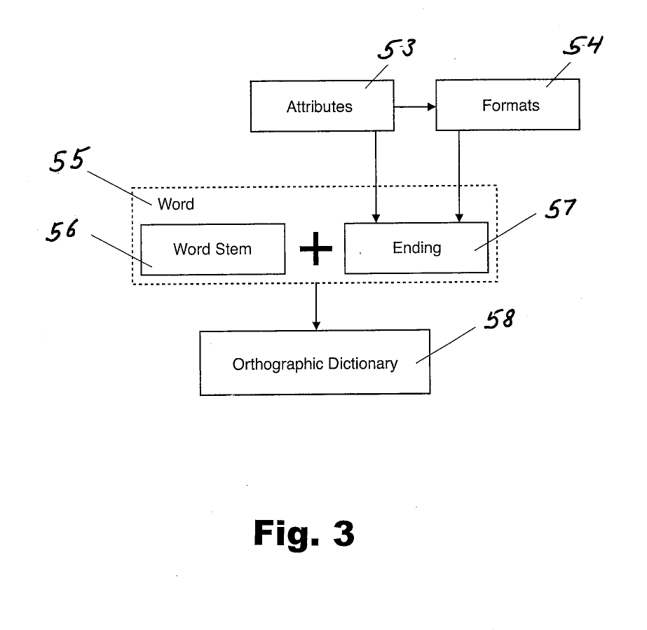

The principle of filling orthographic dictionary is shown in FIG. 3.

Attributes 53 determine parts of speech and their possible characteristics and indicators. All attributes are listed in the MTS system's list of attributes 122 (see FIG. 1(c)).

The list of attributes outlines available word characteristics for a given language (usually parts of speech and other grammatical characteristics), combined into specific groups. Attributes are grouped according to such characteristics as part of speech, person, number, tense, case, and so on. Every group contains a list of names or mnemonics for the corresponding attributes, as well as descriptions and commentary.

There are two types of attributes—global (for all languages) and local (for each individual language).

All words 55 in orthographic dictionary is written in a particular form. In order to avoid the need to enter all word forms, they are divided into an unchangeable component, Word stem (sometime referred to as a ‘root’) 56, and a changeable part, an ‘ending’ 57.

As noted above, separate categorized endings can be used with various stems to generate word forms (for example like=>likes, liked).

Also as noted above, endings form not only form specific word forms, but also carry information about many characteristics of the word such as part of speech, number, ending (masculine/feminine/neutral), case, tense, etc.

Formats 54 are a series of attributes which can be used for description of ending positions. All formats may be found in the list of formats 123.

Formats complement the endings, make the work with them more comfortable.

It's also worth noting that the dictionary has a «nest» structure and contains two types of entries: Main word and Nested word. Nested words are formed in a similar way as main words, they also have a single stem meaning, but they are different parts of speech (or they have a significant variation in attributes), and as such require a different format. Main words are listed as linear entries, and their slave words are written with an indentation. For some words several levels of nested words are possible.

Basically, a dictionary nest is a combination of a main words and its nested words.

### Dependencies

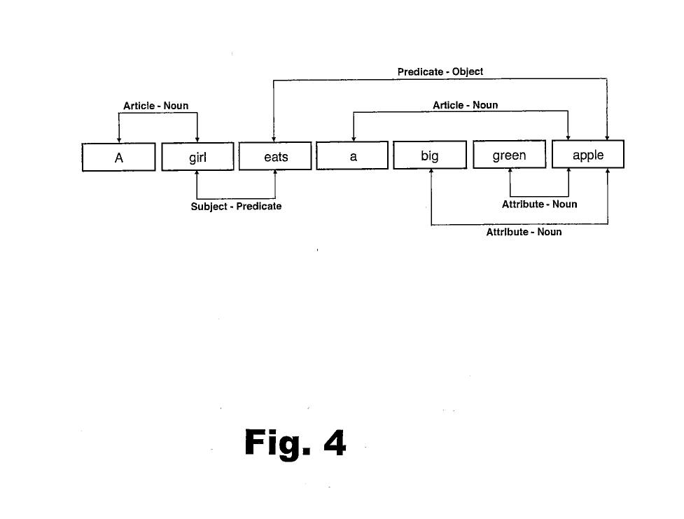

Dependencies are connections or correlations between two words and usually signify a grammatical relationship between these words. An example of a dependency for the English language is illustrated in FIG. 4.

All dependencies for a particular language can be found in the list of dependencies 121. Dependencies are set for a specific language and the system refers to them during the operation.

There are two types of dependencies—Global (for all languages) and Local (for each individual language).

Every dependency is used only between two words and consists of three elements:
Name/mnemonic;
Parameter for the right-side word in the dependency;
Parameter for the left-side word in the dependency.

Dependencies are processed in a special way. The assistant grammar should be created for each dependency. This grammar will check the compatibility and set dependency if it is possible.

### Grammars and Rules

The basic elements of the system are governed by rules (these rules are written in the internal programming language of the machine translation system). The rules are used to translate each word, sentence, or paragraph correctly from the original language into the result or target language.

Rules are a set of instructions that are responsible for processing linguistic information. A separate library of rules is created for each language. Using these rules, MTS will categorize sentence structure and determine grammatical dependencies between all words.

Grammar is a set of rules that describe the sequence of conversion of linguistic information during the translation process. Grammars come into play after a sentence entered into the system has been divided into a series of words with attributes assigned to them.

The grammar for a particular language may be written only when all of the necessary attributes, formats, endings and dependencies have been created. A sufficient quantity of words has to be entered into the orthographic dictionary in order to allow the system to recognize simple sentences.

MTS has two kinds of grammars: Main and Operational.

Main grammars are grammars of analysis, translation grammars and grammars of synthesis. These grammars function during the processes of analysis, translation and synthesis.

Operational grammars include service grammars, dictionary grammars and assistant grammars. They are designed to carry out minor procedures and are called out from working grammars or translation dictionary.

The separation of grammars into groups of analysis, translation and synthesis gives a more logical organization of the system for linguists. MTS has equal access to all grammars in these groups.

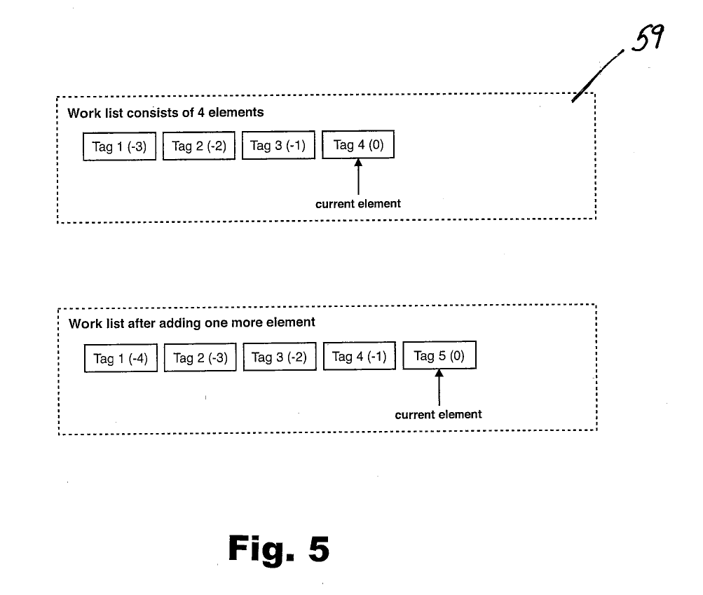

Every grammar has a special buffer for saving data called the work list 59 as illustrated in FIG. 5. The work list saves values of input parameters and intermediate words loaded during the processing of rules.

The sequence of elements in the current list does not necessarily correspond to the word order in the input text. These elements can be rearranged into an order determined by the rules. There can be situation when various elements of the current list can correspond to a single word in the text.

Referencing individual elements in the list is done by using a system of relative indexing (relative to the current element's position). The current element (the furthest to the right one) has the index 0 (zero). The element to the immediate left of it has the index −1, and the element to the left of it has an index of −2. Reference to a positive element is not possible and will cause an error, as these elements are not yet a part of the list.

Current element is the element located in the furthest right position of the list (FIG. 5).

Each grammar works on the principle of ‘OR’, that is a grammar which is considered to be active if at least one of the rules in the grammar is validated. Rules are written on the principle of ‘AND’. A rule is considered to be valid if all conditions are met.

Rules operate with the logic ‘IF/THEN’. Rules can perform the following actions: test a specific condition; load or delete words in the work list; set or modify a dependency; or modify the original text.

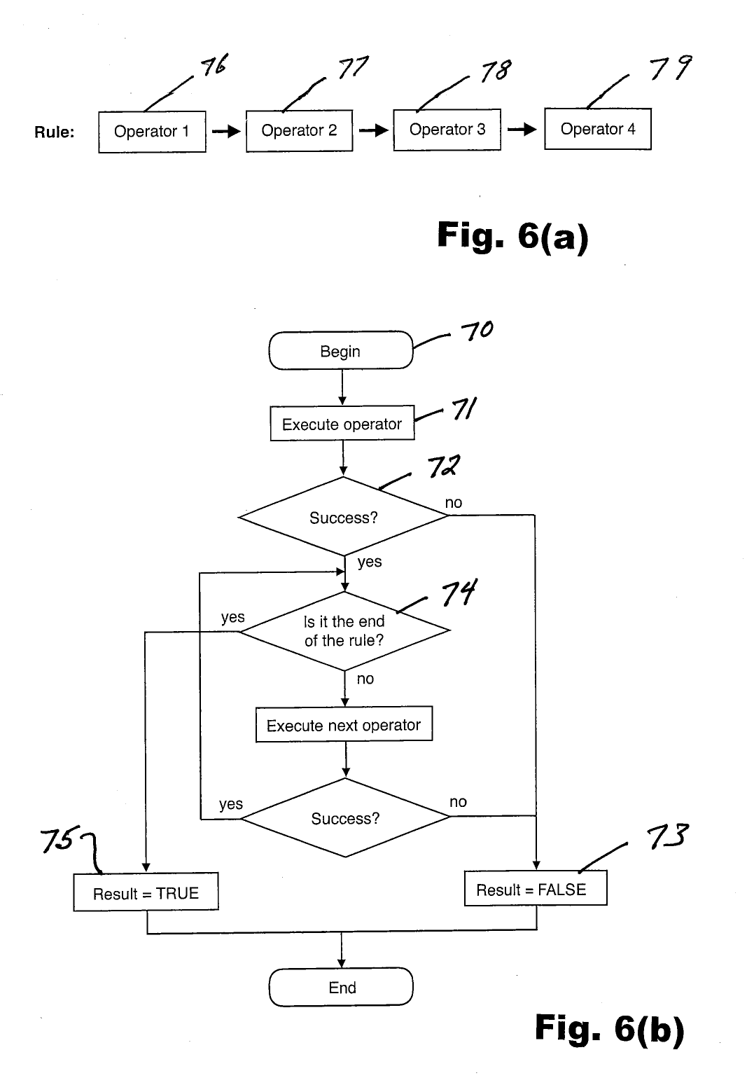

Each rule is a set of operators 76 et seq, executed sequentially. For example, if it is necessary to add a word to the text and certain conditions are met, it is possible to use checking operators at the beginning, then modification operators. The opposite is also possible, first modification, then checking. Every component returns TRUE if it has worked successfully, or FALSE if its conditions were not met (FIG. 6(a)).

As illustrated in the flow chart of FIG. 6(b), a rule begins at 70 to from or execute 71 the first operator 60. If the operator returned TRUE 72, it is considered to have «worked» and next operator starts.

If the first operator did not work, the rule which contains the operator stops processing (further operators in the rule are not processed) and returns FALSE 73. The rule did not work.

If the working operator is the last one in the rule (step 74), the rule is considered to have been executed (it has returned TRUE) 75.

Any changes will take effect only when all operators return TRUE.

Operators can make changes in the current list, such as change, add, or delete words, delete alternate versions of words, and add/delete attributes and dependencies. These changes to the current list are carried out in the form of the sentence and are implemented in the sentence only if the main grammar worked fully (that is returned TRUE). If the grammar returned FALSE, the form of the sentence with its changes is cleared and the input sentence remains as it was after the last successful main grammar activation.

When the main grammar has worked, the process is at the end 76 and the changes are irreversible.

If a rule is not executed, the changes carried out by the operators within the rule are canceled. The translated text and the current list of parameters is returned to the form in which they were before the rule was activated. Then control is transferred to the next rule of the same grammar.

### Storage of the Rules in the System

It often happens that rules designed to perform similar procedures have the same components. For example, start with the same operator (or the same group of operators).

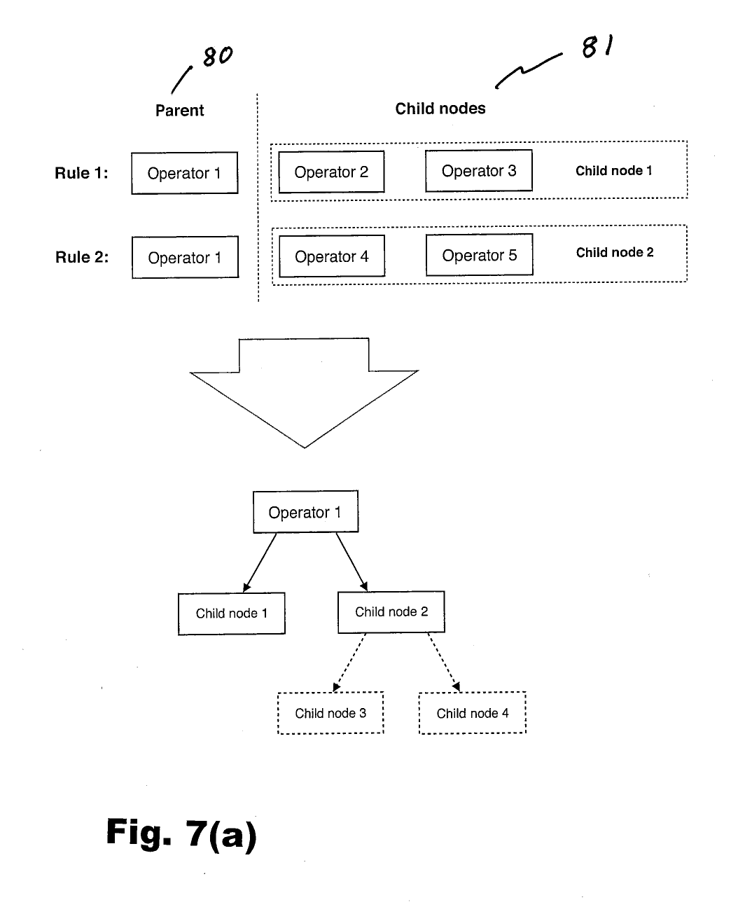

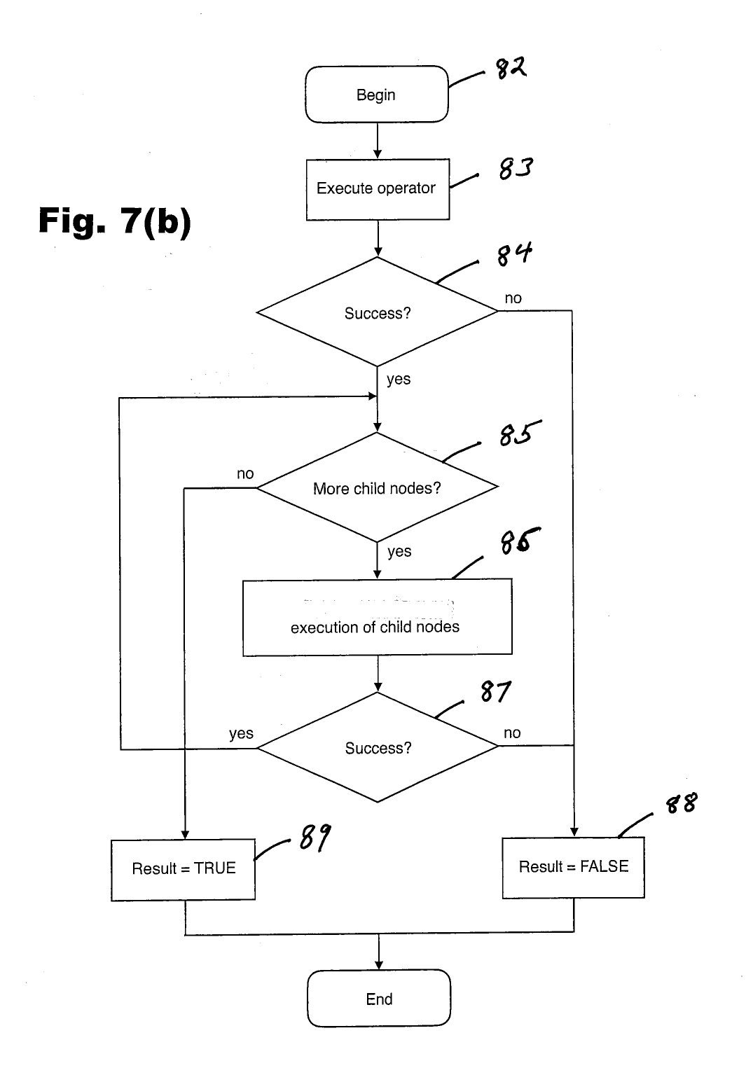

In order to optimize such rules, they are grouped together and stored in the system as a tree structure (FIG. 7(a)). For example, if a few rules begin with the same operator, it is saved as the Parent 80, and all of the following structures as Child nodes 81.

Subsequently, when working with this group of rules, the system performs once the parent, then run only child nodes (which can also have its child nodes, performed on the same principle).

FIG. 7(b) illustrates the process, which begins at 82 to execute at 83 an operator. If successful at 84 a child node may be operated 85. And if that is successful execution of the child node occurs at 86 and if successful 87 the process may continue. If not, then the result is a FALSE 88. If there are no more child nodes after success, then the process is complete with a TRUE result 89.

With a large number of rules, this method can significantly increase the work speed and reduce the memory volume occupied by them.

Main Grammars with the Sentences

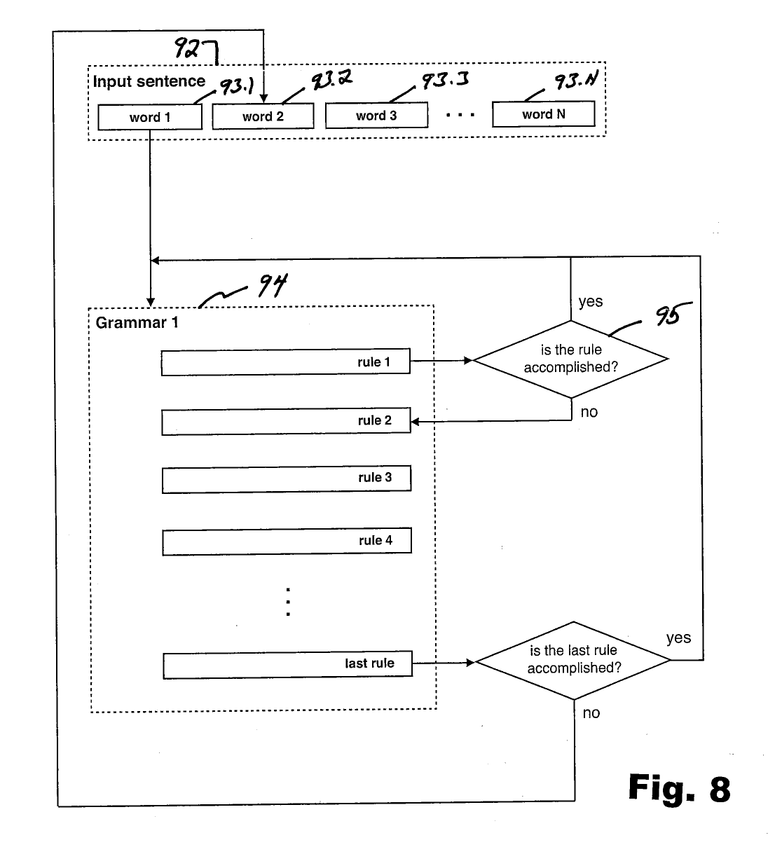

Processing of a group of words (such as in a sentence 92 with words 93.1, 93.2, 93.3-word 93.N) is carried out by main grammars according to their order (FIG. 8). Each of the words is tested by each of the grammars in their order of procession, and then all of the rules which the grammar consists of are implemented in ascending order. So, word-1 is given to grammar 1 (94), to apply rules 1-last rule. If the conditions of a rule are met, then the process starts from the top again. Wherein the rules, which could not be applied before because there were not enough conditions, can be applied now.

The cycle continues until all rules have been applied. The process stops as soon as the conditions of a rule are not met at 95. At this point the next word is put through the grammar and the process is repeated. If the last words in the sentence has been processed, the system moves on to the next grammar and begins to process the first word through it, and so on until all words have been processed through all of the grammars.

When all rules in a first Grammar 94 for word N are not accomplished, the whole procedure starts again, but with a second Grammar. The word 1 is processed by the second Grammar and so on until all words have been processed through all of the grammars.

On this principle the procedures of analysis, synthesis and translation work well.

There are several types of grammars, the operating principle of which may differ slightly. For example, the U-type grammar in the case of the rule applied does not run for the same word, but for the first word in a sentence, whereas Vtype grammar works with words from a sentence in reverse order.

### Assistant Grammars

As stated earlier, grammars are divided into two groups: main grammars (analysis, translation and synthesis) and operational grammars (service, dictionary and assistant).

Execution of main grammars is initiated by the system. Operational grammars are used by the system (service grammars). They can also be called from the rules of other grammars (assistant grammars) and translation dictionaries (dictionary grammars).

Assistant grammars are called from the rules of main grammars. The first assistant grammar can implement the second assistant grammar, which implements the third assistant grammar, and so on. It is also possible that an assistant grammar can implement itself recursively.

Assistant grammars, when activated, work once and return TRUE, FALSE or any meaning (word from sentence). For example, assistant grammars can be used to set dependencies, to find any word in sentence, to check the condition, and so on.

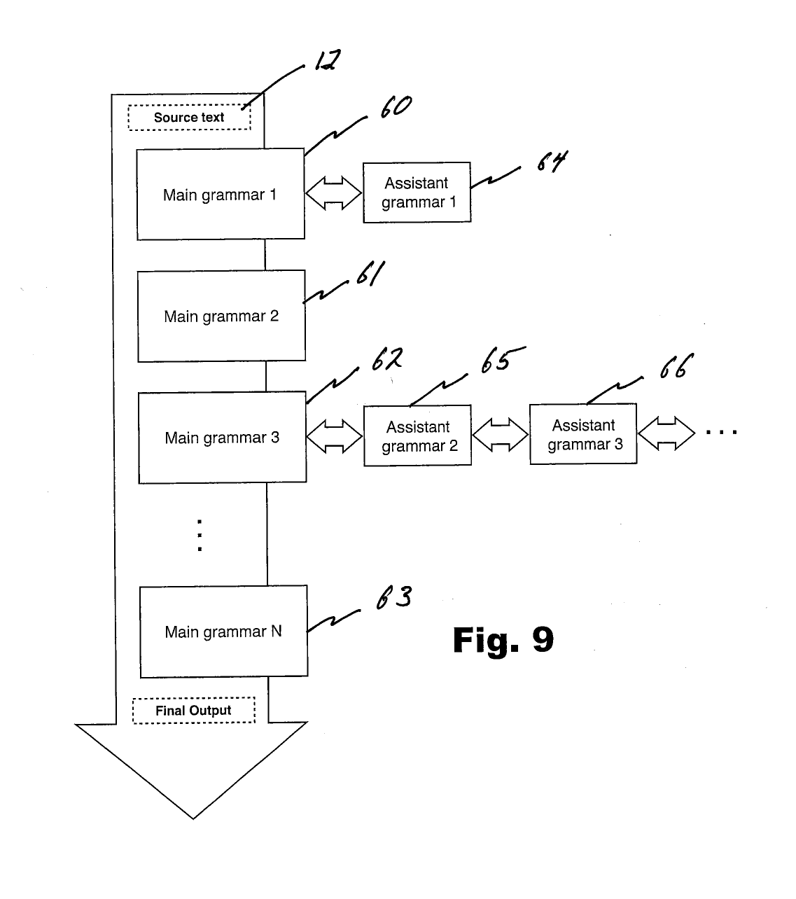

FIG. 9 illustrates the process where main grammar-1 60 operates on source text 12 and then calls assistant grammar-1 64. Main grammars 1-N, as well as assistant grammars-2, 3, etc. (65, 66, etc.) are called on to operate on the text.

### Phrase Structure

Translation of words is contained in the translation dictionary 126. This dictionary consists of consecutive entries, which contain word-by-word translation from one language into another.

The translation dictionary 126 also includes translations of phrases. The phrase structure used within the MTS allows to transform the meaning of a phrase and grammatical dependencies between words from one language into another.

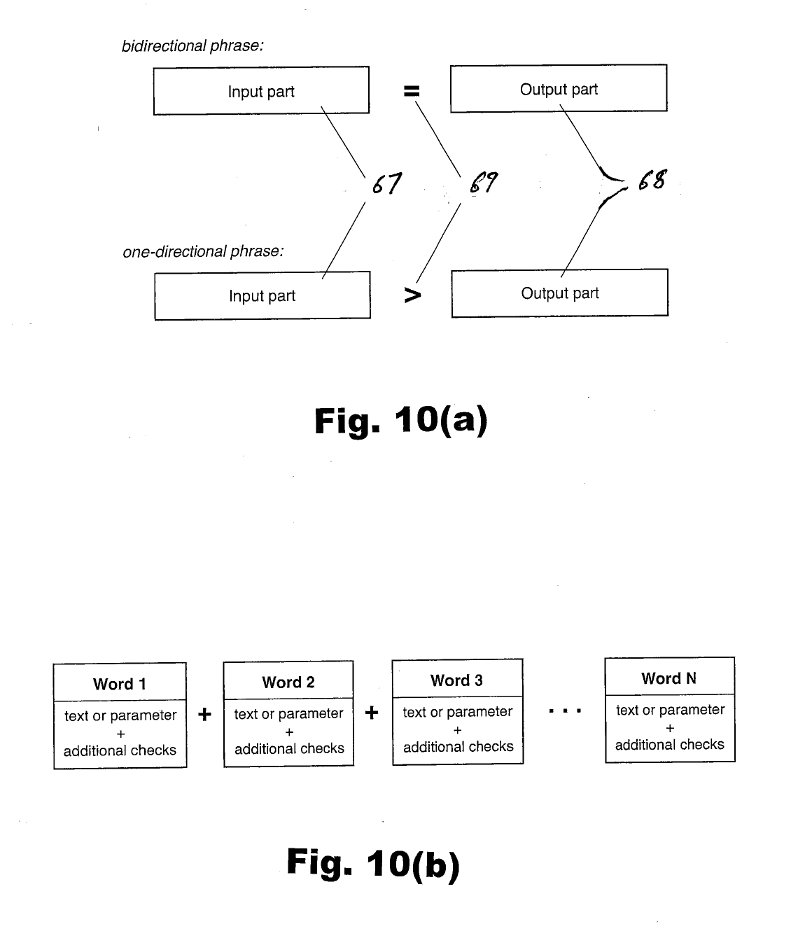

In the translation dictionary 126 any phrase has two parts as illustrated in FIG. 10(a), input language (word or phrase) 67 is located on the left side (input part) of the translation, and the translation result 68 is on the right side (output side). For example: casa verde=green house. Here «casa verde» is an input part 67 of the phrase, and «green house» is the output part 68.

Between these parts a divider 69 is located, being either «>» or «=», which indicates translation direction, from left to right or bidirectional.

Divider «>» signifies that translation is possible only in one direction (from the input language to the output one).

Divider «=» indicates that translation is equivalent for both languages and works in both directions.

There are three types of phrases: simple phrases, contextual phrases and parameterized phrases.

A simple phrase does not contain any additional structures (but can contain additional checks).

In contextual phrases the possible context of the sentence is taken into account, and the translation of the words in such a phrase depends on the context that surrounds them. This type of phrases can also contain additional checks.

Parameterized phrases enable formation of translation patterns (Parameters) for a wide array of similar sentences. Each parameter corresponds to an appropriate grammar, which checks the correctness of a word or word-combination placement into a given phrase. These type of phrases can also contain additional checks. A set of parameters depends on language. Here are a few examples of parameters, used in English:
(i) &table—means that any inanimate noun can be used, including “table” per s;
(ii) &cat—means that any animate noun can be used, including the noun “cat”; and
(iii) &red—stands for any adjective indicating color.

Parts of phrases (both, input and output) structure are shown in FIG. 10(b). Both parts of a phrase can contain any number of words or parameters, and additional checks after every unit. One important thing to note is that it is impossible to create phrase only with parameters, without any text.

Additional checks (set by attributes or dictionary grammars) are needed for correct processing of all word forms of a given word. It allows to avoid various errors, for example those related to the written form of a word in different registers or the use of articles.

### Phrases

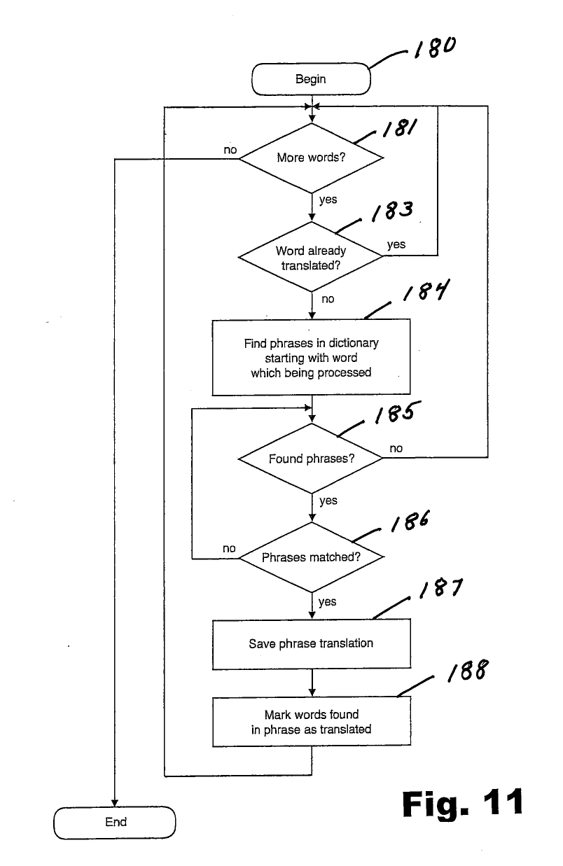

The system's work with phrases is shown in FIG. 11. When the system receives, at the begin point 180, an untranslated word, it tries to find at 181 in the dictionary all phrases that begin with this word. If the phrase is not found, the system simply translates this word and moves on to the next word in the sentence and this process ends at 182.

If phrases have been translated 183, a search 184 finds the phrase in the dictionary starting with the word which is being processed and are found 184, the system selects the most suitable one in this situation 185. After selecting a phrase 186, the system retains 187 its translation and marks the words that are found in this phrase as translated 188.

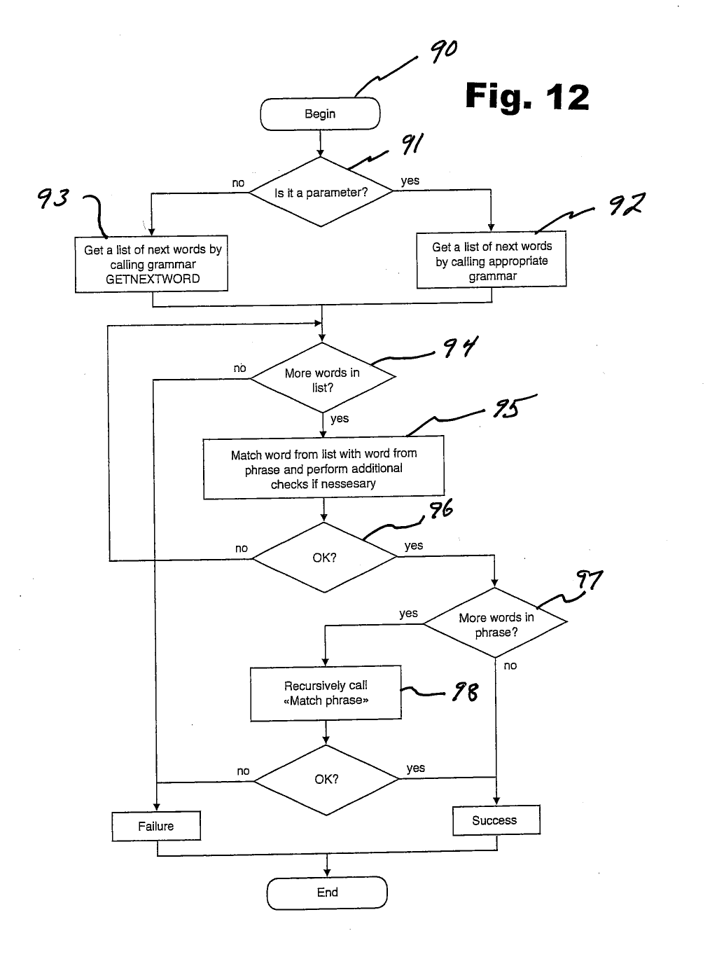

The process of «Match phrase», illustrated at FIG. 12, checks whether the found phrase is suitable for translation.

Testing begins at 90 with the decision if the word in the phrase is a parameter 91. If so, grammar associated with this parameter is called 92. If not, the work begins with a list of next words by calling grammar GETNEXTWORD 93.

If the text does not contain more words, the work of translation is finished. If the words are found 94, they are reconciled at 95 with the words of the phrase found. In this case, if necessary, additional checks are carried out 96.

Then words are searched in the phrase again, and if they are found 97, then the «Match phrase» runs recursively 98.

Service grammar named GETNEXTWORD is created by linguists for all languages in the system. This grammar is used by system (during translation) to search for the next word in a sentence and compare it with a word in a phrase. This grammar includes rules to choose the next word in a sentence. A set of the rules depends on language structure.

In a dictionary phrase the words are consecutive, but in the real text there can be one or more words between them. In the grammar GETNEXTWORD there are rules according to which words standing between words in phrases can be omitted, so that the phrase works.

For example, thanks to the grammar GETNEXTWORD, phrase «on table» works correctly in sentence like «on the table», «on a table», «on the green table» and so on. Without this grammar, phrase «on table» will work only for the sentence «on table».

### Translation Grammars

The term «translation» in the system means not only work with the translation dictionary 126 and phrases, but also will work with translation grammars.

Technically translation grammars work like other main grammars (Analysis and Synthesis). But it is destined for translation dependencies and attributes. For example, thanks to the translation grammars, the English article is not translated into Ukranian, because this language doesn't have any articles.

But translation grammar rules are not limited to a primitive translation of dependencies and attributes. It is also possible to input any phrase if the translation dictionary that lacks the capability to create it. Any output construction can be created from any input construction.

Wherein linguists must try to do as little work as possible in translation grammars and leave more work to synthesis. This is because everything that is given in translation grammars only pertains to a specific pair of languages, but synthesis works independently of the input language (it works solely with the output language).

In this way translation grammars are not quite suitable for indirect (transit) translation.

### Indirect Translation

Indirect (transit) translation is a method that uses translation via one or more intermediate languages between input and target languages.

Morphological synthesis is absent for transit languages, and the completely analyzed (marked) sentence is relayed to the next translation.

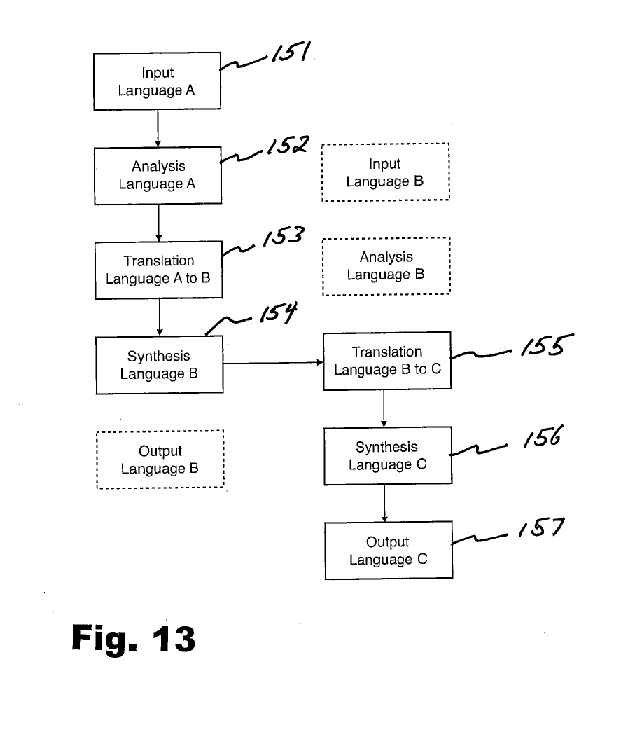

The steps which the system takes during translation from language A into language C via language B are illustrated in FIG. 13. There is no analysis for language B, the results of analysis for language A being used instead.

First, an input or source language is input to the system at 151, analysis is performed at 152 and translation is made at 153 from language A into language B. But the results of the synthesis at 154 are not send to GUI (shown in phantom lines), rather, they are immediately sent for the translation at 155 into language C. Synthesis can then be performed at 156 on language C and the result output at 157.

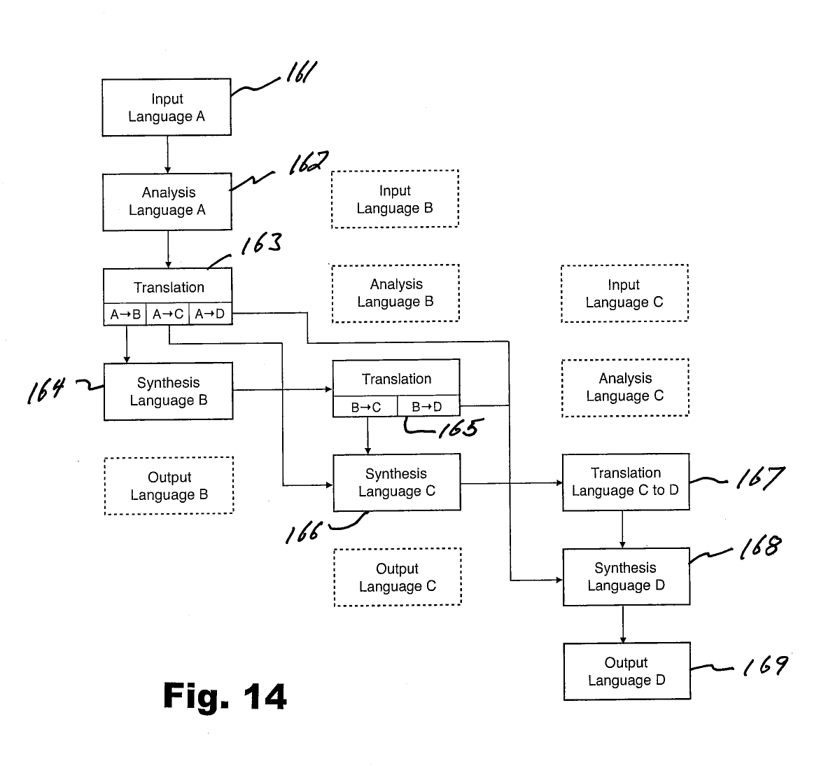

The same logic is applied for the schematics in FIG. 14, which shows the steps for translation from language A into language D, via languages B and C. Indirect translation can be successfully used in the construction of multilingual translation systems.

At first, an input or source language is input to the system at 161, then, after analysis at 162, translation is made from language A into language B 163. The results are sent for synthesis of language B 164 and then translation into language C at 165. Then the obtained result is subject to synthesis at 166 and translated at 167 into language D. The end result, after synthesis of language D at 168, goes to a GUI at output 169.

At the same time, if in the translation dictionary 126 or Memory Translation there are available direct phrases from language A into language C or from language A into language D, they can also be used as shown by alternate paths. It will significantly improve the translation quality.

In transit translation a user will not see the whole chain of steps and intermediate translations. To the observation of a user, for him the translation appears to be carried out directly from language A into language D.

### Form of Communication or a Gender of Interloculors

During translation the system is able to take into account the form of communication and the gender of interlocutors. These can be especially useful during a live communication, such as illustrated in FIG. 17, for example, via messengers.

Special grammars written in an internal language of the system are applied for this kind of translation between persons taking part in the communication (interlocutor). The content of these grammars depends on the languages used for communication. For example, in Spanish it is possible to know about the form of communication on the presence of such words as “Tú” or “Usted”. An example of informal versus polite forms can be seen in this example of translation from English to Spanish:

Informal form:
Interlocutor 1: «¿A qué hora vienes mañana al trabajo?»
(translate to: «What time will you come to work tomorrow?»)
Interlocutor 2: «I'll be at 8:00. And what time will you come?»
(translate to: «Vengo a las 8:00. Y tú ¿a qué hora vienes?»)

Polite form:
Interlocutor 1: «¿A qué hora viene usted mañana al trabajo?»
(translate to: «What time will you come to work tomorrow?»)
Interlocutor 2: «I′ll be at 8:00. And what time will you come?»
(translate to: «Vengo a las 8:00. Y usted ¿a qué hora viene?»)

In Japanese the form is determined by the endings of words and the special verbs. With knowledge about particular words, linguists can easy identify the form of communication.

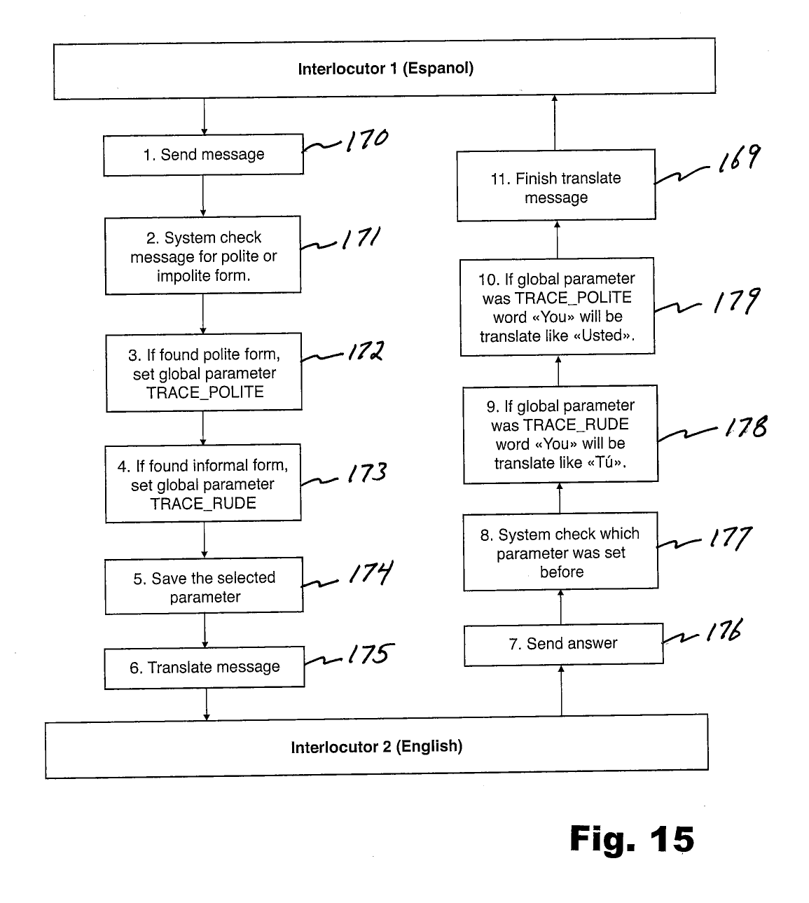

For example, as illustrated in FIG. 15, Interlocutor-1 sends a message at 170 to the system. The system at 171 checks the message for the polite or informal form at 171. If the polite form is found 172, then a global parameter of TRACE_POLITE is set. Communication will then continue in the polite form. If communication is determined to be informal, then global parameter is TRACE_RUDE 173. In either case the selected parameter is saved 174 and the message is translated at 175 and then displayed to Interlocutor-2. The same process is followed for the answer from Interlocutor-2 to Interlocutor-1 in steps 176-179 and then finish the translation at 169.

The gender of the interlocutors is determined by similar methods. But in that case the global parameters are DST_FEM and DST_MASC for female or male gender.

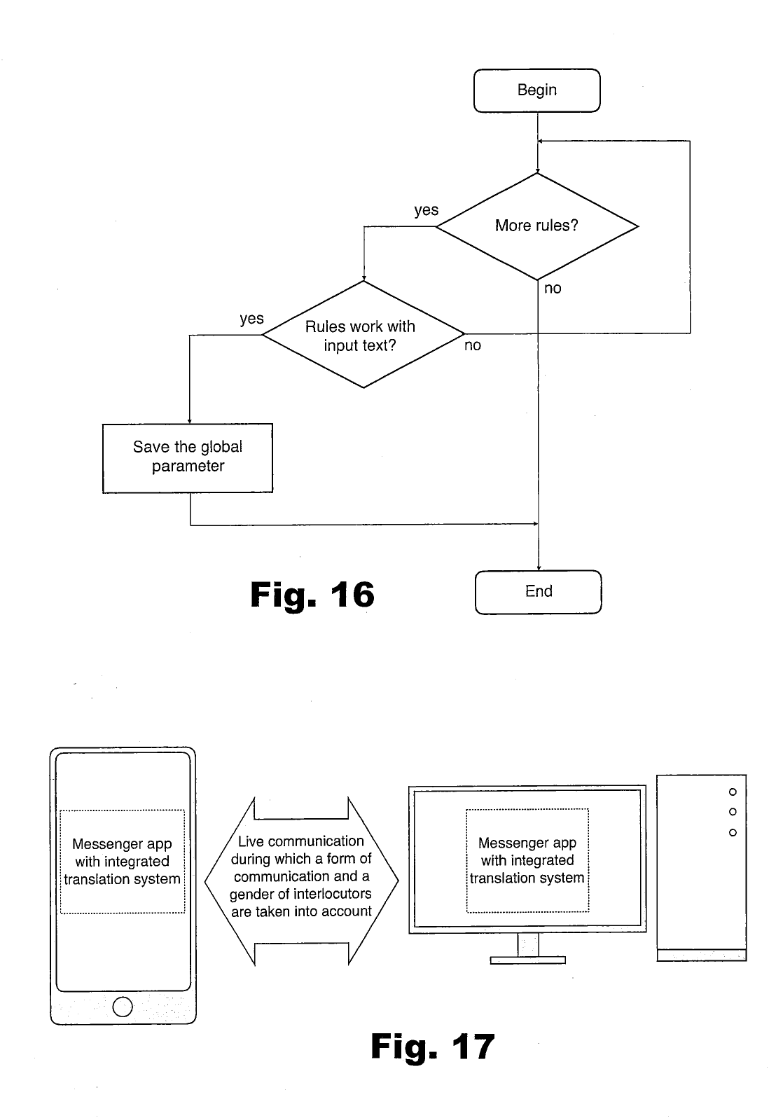

The system tries to apply to the result text during the translation for it specially created rules. If at least one of the rules works, a corresponding global parameter is appointed as illustrated in FIG. 16.

### Language Detection Module

This system is designed to improve the accuracy of language auto-detection and is used in our system.

There are cases when it is hard to identify the language used by a user. One example is a conversation consisting of a single word that spells the same way but means different things in different languages. Our system operates an auto-detection mechanism that memorizes the user's preferred language of communication. Later on, this language takes precedence when using the auto-detection feature.

By way of example, the word “chair” has completely different meanings in English and French. Thus, with auto-detection enabled, the system will necessarily take into account the user's preferred language. If he or she prefers French, the text will receive an appropriate translation.

This feature can be especially useful when using the translator with instant chat messages, especially for related languages, such as Ukrainian and Russian or Spanish and Portuguese, for which auto-detection is difficult due to a large number of identically spelled words.

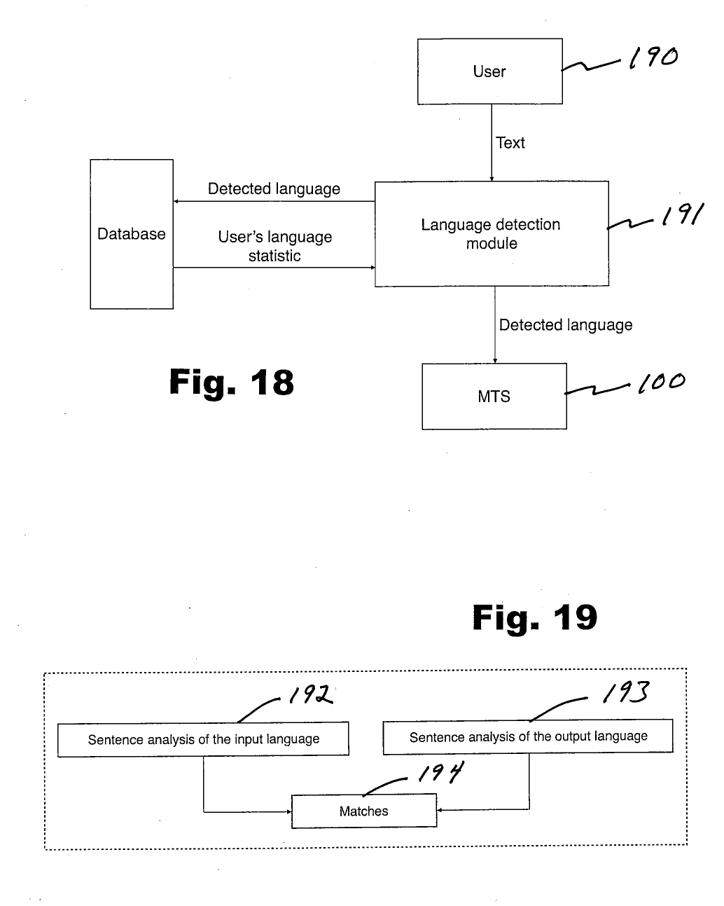

FIG. 18 illustrates this process, as follows. After the user 190 sends the text, it is received in the language detection module 191. This module pre-determines the language and runs an additional check by sending a request to a special database 192 with user information, including the language preferred. Having received the user's language statistic, the language detection module makes the final choice. When the choice is ambiguous, the user's preferred language takes precedence over other languages. Information about the selected language is then transmitted to the machine translation system (MTS) 100.

### Self-Learning Block

A self-learning block allows the system to automatically teach itself by filling the dictionary with new phrases created from parallel texts. For this procedure to work, a linguist must first load the bodies of the texts into the system self-learning block. Then the system analyzes them and creates word matches. Based on the information generated in the process, the system self-learns. The procedure can be broken down into two stages: loading (during which the bodies of the texts are fed into the system) and learning per se.

The loading stage includes feeding parallel bilingual texts into the system. The system analyzes the two texts and matches the sentences. The analysis is powered by a methodology consisting of rules bundled into grammars A set of grammars and rules depends entirely on the properties of the sentences' language.

The matching principal is described below. Everything works automatically based on the system's set of synonyms.

FIG. 19 illustrates this loading stage. Sentence analysis is first performed on the input language at 192. Sentence analysis is also performed on the output language at 193 and the results are compared for matches at 194.

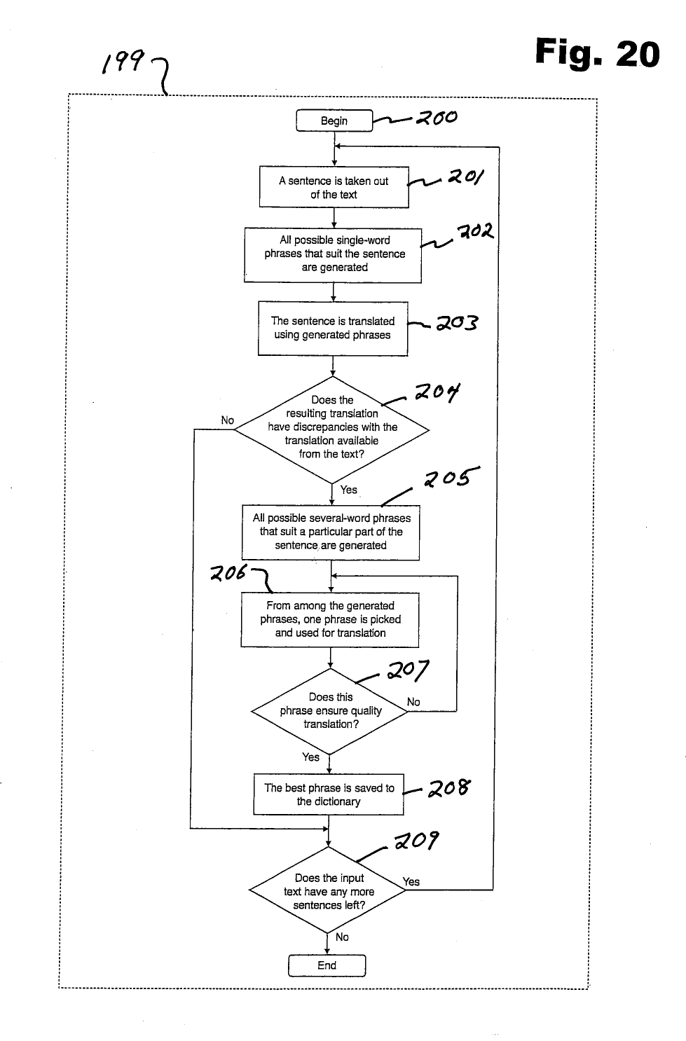

After analyzing both sides and making word matches, the system starts to self-learn. This learning stage 199 is illustrated at FIG. 20 and occurs in 7 stages.

Stage 1: First, after the input text is provided at 200 and a sentence is isolated from that text at 201, the system generates all possible versions of single-word phrases at 202. That is, each word from the input sentence is matched to a word in the input language. If there is no match, the word is assigned a void translation. When making such phrases, statistical information is used, meaning that if a word has two potential translations, the system will pick the one that has the higher statistical presence in the parallel texts.

Stage 2: Then the system takes one input language sentence out of the texts and translates it at 203 again, using the phrases generated at 202.

Stage 3: The sentence's resulting translation is matched at 204 with the translation from the parallel texts, and Stage 4: The system runs a translation discrepancy check (by comparing the system-generated translation to that available from the texts). In case of no discrepancies, the system goes back to 202.

Stage 5: Should any discrepancies occur, the system generates new phrases at 205, each made up of several words (up to a phrase that exactly matches this part of the sentence). The process involves only the parts of the sentence that were translated with discrepancies.

Stage 6: By sorting through the generated phrases, the system picks the one that best meets the translation objectives at 206, and saves it to the dictionary at 208, and goes to stage 2.

Stage 7: The procedure repeats itself until there are no sentences left in the texts 209.

### Matches

A match is a link between words in the input and output parts of phrases making up the dictionary (i.e. a reference from a word in the input language to a word in the output language). Without matches, phrases cannot work right.

A match is necessary to link a word on the left-hand (input) side of a phrase to a word on the right-hand (output) side to show which right-hand words will take their grammar properties from left-hand words. A match captures a word's translation and helps avoid a repeat translation of the word in a phrase if the word has already been translated in a previously triggered phrase.

Also, matches are needed for the work of grammars triggered after the translation dictionary stage. For example, a match can be used to go back to a word in the input language to verify necessary information and then modify the output sentence.

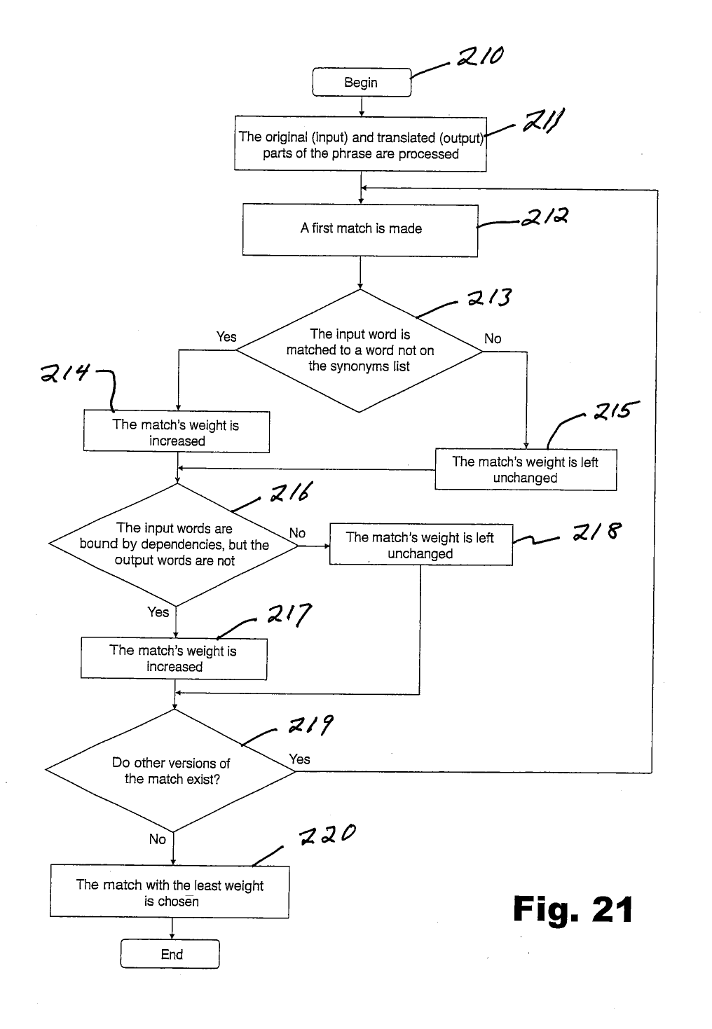

One of the system's features is the automatic assignment of matches immediately upon entering a phrase. Although linguists have the ability to manually adjust the previously assigned matches, it will not be necessary in most cases, because of the mechanism operating on the principle shown in FIG. 21.

The match assignment principle consists in tying the words from the input part of a phrase to the words from the output part. Suppose there is a phrase made up of three words on either side: A1 B1 C1>A2 B2 C2

The word A1 from the input part can be matched to one of the words A2, B2, and C2 from the output part, depending on the properties of the languages involved. The words B1 and C1 should also be matched to words from the output part of the phrase.

The system first processes all possible matches and evaluates their “weight.” If one of the possible conditions holds true for a match, the system increases the match's weight. There are two conditions:
(i) a word is matched to a word not on the (previously created) synonyms list; and
(ii) the input word is part of a specific dependency, but the corresponding output word is not.

If a condition is not met, the match's weight remains unchanged. When all possible versions of the match have been processed, the least-weighing match is chosen.

After the beginning 210 of this process, the original (input) and translated (output parts of a phrase are processed at 211, and a fist match is made at 212. The input word is matched to a word not on the synonyms list at 213. If there is a match, then at 214 the match's weight is increased. If not, as at 215, the matches' weight is unchanged. In either case, at 216 the input words are bound by dependencies, but the output words are not. Again if there is a match, then at 217 the match's weight is increased. If not, as at 218, the matches' weight is unchanged. Next, at 219, whether or not other versions of the match exist is determined. If yes, the process repeats at 212. If not, then the match with the least weight is chosen at 220.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A computer based translation system for translating text of a source language (source text) to text of a target language (target text) thereby conveying meaning of said source text from one natural language to another, comprising
a computer having a core with a modular structure supporting a plurality of modules for performing text translation,
an input device coupled with said core, said input device transmitting to said core said text of said source language for translation,
a screen for displaying a graphical user interface (GUI) coupled with said core,
said modules maintained on said core for effecting analysis of said source text, identification of all parts of said source text, identification of dependencies between words of said source text, effecting translation of said source text into said target text, and for displaying said target text on said GUI,
said plurality of modules including:
(a) a language detection module configured for inputting the text of said source language into the system;
(b) a rules processing module configured for correct operation of rules which guide the functioning of other modules;
(c) a lexical analyzer configured for lexical analysis of the text said source;
(d) a text analysis module configured to analyze said source text;
(e) a translation module configured to produce translation of the source text to the target text;
(f) a memory translation module configured to provide memory translation; and
(g) a text synthesis module configured to perform synthesis of the target text,
at least one additional module coupled with said core including at least a rules and grammar module, an orthographic dictionary, a translation dictionary and a memory translation dictionary,
said rules and grammar module containing attributes to determine parts of speech and their possible properties and characteristics, and dependencies as grammatical relations between two words within a sentence, wherein grammars transform linguistic information and consist of lists of rules,
said orthographic dictionary containing words with all distinctive attributes, said translation dictionary containing word-by-word translations from one language into another, said memory translation dictionary having ready-made phrases, and
a removable plug-in module which may be operatively coupled to said core supporting at least a self-learning block having a matches module configured for linking words in the source text and the target text.

2. The computer based translation system according to claim 1, wherein said rules and grammar module transforms linguistic information and includes a list of rules, which are performed consecutively, and wherein said rules are characterized as a sequence of operators.

3. The computer based translation system according to claim 1, wherein said translation dictionary includes consecutive entries, wherein said word-by-word translation are contained in one lexical unit after another, wherein said translation dictionary includes translations of phrases from one language to another, wherein said translation dictionary operates with parameterized phrases, which enables formation of translation patterns for similar source texts, wherein each parameter corresponds to a dedicated grammar which checks the correctness of word or word combination placement into a given phrase.

4. The computer based translation system according to claim 1, further comprising a Linguistic Support System (“LSS”) remote from said core and which may be operatively coupled with said core, wherein said LSS allows linguists and translators to monitor the translation process, edit dictionaries, add translations of language pairs and ensure learnability of the system.

5. The computer based translation system according to claim 3, wherein said grammar includes specialized grammars taking into account the form of communication or a gender of interloculors.

6. A method for translation of text of a source language (source text) into a translated text conveying its meaning from one natural language to another natural language and comprising
entering said source text into a computer configured to perform said translation through a graphical user interface, said graphical user interface being coupled to a core of said computer,
analyzing said source text;
translating the source text into a translated targeted text;
synthesizing the translated targeted text;
analyzing source and target texts thereby establishing matches resulting in self-learning automatically filling the dictionaries with new phrases for self-learning;
wherein said step of analyzing said source text divides strings of symbols into separate words and results in an unambiguous identification of all parts of speech, wherein said step of analyzing said source text further results in a set of grammatical relations between two words within said source text known as dependencies;
wherein said step of translating comprises word meanings being translated into a target language, and changing the position of words in accordance with the grammar of the target language, and wherein said dependencies become transformed;
wherein said step of synthesizing includes replacement and insertion of service words, and adjustment of endings, applying rules of text transformation, which are consolidated into grammars for each of said steps of analyzing said source text; translating the source text into a translated text; and synthesizing, wherein said step of synthesizing results in a fully tagged structure of text in the target language without analysis, wherein said synthesizing into a fully tagged structure of text in the target language without analysis is a transit translation; and
conveying said translated text to an output on a graphical user interface for viewing said target text.

7. A method for translation of a source text conveying its meaning from one natural language to another natural language and into a translated text, comprising
entering said source text to be translated into a field of a GUI for entering said source text to a core of a computer configured for translation of said source text;
initiating a translation process;
separating said source text into tokens;
identifying lexemes from the tokenization step;
assigning attributes to said lexemes;
analyzing said lexemes;
eliminating ambiguities of said lexemes;
establishing dependencies between words;
applying translation grammar and synthesis grammar to the translated text in order to determine if in the translated text there are: lexemes; attributes assigned to each token; and dependencies between tokens;
applying rules of synthesis to correct any excess or deficiency of the attributes in said translated text and any excess or absence of dependencies in said translated text, and correcting any word order in the translated text;
analyzing source and target texts thereby establishing matches resulting in self-learning automatically filling the dictionaries with new phrases for self-learning;
wherein a token is an element that represents a sequence of symbols grouped by predefined characteristics, such as an identifier, a number, a punctuation mark, date, or word, each token within a source text being separated by a space, so that all elements located between spaces are identified as separate tokens, wherein said grammar is a functional block that transforms linguistic information and includes of a list of rules, which are performed consecutively,
wherein grammar rules, comprise a sequence of operators,
wherein grammars work with incoming linguistic information, divided into tokens with defined initial attributes that are obtained from an orthographical dictionary,
wherein grammar has input parameters, through which information is received, wherein real values of parameters are provided to grammar input,
wherein said values are stored in a current list, said current list being an internal buffer for storing results of intermediate modifications, and
conveying said translated text to an output for display.

8. The method according to claim 7, wherein operators produce changes in current lists, said changes include adding or removing tokens, removing word variations, adding or removing attributes and dependencies, wherein said changes of current lists are made on sentence images and are transferred to said sentence itself only if a main grammar is triggered, wherein, if the grammar did not trigger, the image of sentence with changes is deleted and the initial sentence remains in the form it was after last being processed by grammar when said main grammar is not triggered, wherein all changes in the sentence become irreversible after the main grammar is triggered, wherein there are three groups of grammars, wherein said three groups of grammars are a grammar of analysis, a grammar of translation; and a grammar of synthesis, further comprising operational grammars including a grammar of service, a grammar of dictionary; and a grammar of assistant, further comprising using a dedicated orthographical dictionary which contain words with all distinctive attributes, wherein said dictionary is structured in families with indication of all possible variations of use of a word without translation, wherein said translation process includes translation of words and phrases contained in a translation dictionary, further characterized by translations of phrases included in said translation dictionary.

9. The method according to claim 8, further comprising transforming the meaning of a phrase and grammatical dependencies between words from one language into another, wherein said translation dictionary operates with parameterized phrases, which enables formation of translation patterns for an array of similar source texts, wherein each parameter corresponds to a dedicated grammar, which checks the correctness of word or word combination placement into a given phrase, wherein placement parameters in phrases are filtered by conditions set by attributes, wherein attributes can be added to a phrase for correct processing of all word forms of a given word, wherein parameters will check for specific value use if the goal is to have the phrase applicable to a wider context and, obtaining words that are absent in the orthographical dictionary during the process of word formation for complex words and words with prefixes and postfixes.

10. The method according to claim 9, further comprising accessing a Linguistic Support System (“LSS”) remote from said core and which may be operatively coupled with said core, wherein accessing said LSS allows linguists and translators to monitor the translation process, edit dictionaries, add translations of language pairs and ensure learnability of the system.

11. The method according to claim 10, wherein said grammar includes specialized grammars taking into account the form of communication or a gender of interloculors.
